(19) United States
(12) Patent Application Publication
(10) Pub. No.: US 2026/0187324 A1
(43) Pub. Date: Jul. 2, 2026

(54) NUMERICAL SIMULATION METHODS FOR RAINFALL-INDUCED FLASH FLOOD AND DEBRIS FLOW

(71) Applicant: INSTITUTE OF MOUNTAIN HAZARDS AND ENVIRONMENT, CAS, Chengdu (CN)

(72) Inventors: Jinbo TANG, Chengdu (CN); Peng CUI, Chengdu (CN); Hao WANG, Chengdu (CN); Yilong YU, Chengdu (CN); Xubo JIA, Chengdu (CN); Chunhao WU, Chengdu (CN)

(73) Assignee: INSTITUTE OF MOUNTAIN HAZARDS AND ENVIRONMENT, CAS, Chengdu (CN)

(21) Appl. No.: 19/299,374

(22) Filed: Aug. 14, 2025

(30) Foreign Application Priority Data
Dec. 31, 2024 (CN) 202411981767.7

(51) Int. Cl. G06F 30/28; G06F 111/10; G06F 113/08; G06F 119/14

(52) U.S. Cl. CPC G06F 30/28; G06F 2111/10; G06F 2113/08; G06F 2119/14

(57) ABSTRACT

Disclosed is a numerical simulation method for rainfall-induced flash flood and debris flow, including: obtaining, based on a continuum medium mechanics manner coupled with a hydrodynamic model of a three-phase medium of water, coarse particles, and fine particles, data required for the numerical simulation method. The present disclosure is based on a theory of continuum mechanics, which realizes the numerical simulation method for the flash flood and debris flow considering rainfall conditions by a finite difference manner based on the continuum medium mechanics manner coupled with the hydrodynamic model of the three-phase medium of the water, the coarse particles, and the fine particles. The method in the present disclosure is able to simulate formation, movement, and sediment transport processes of the flash flood and debris flow under different rainfall condition.

### CROSS-REFERENCE TO RELATED APPLICATIONS

This application claims priority to Chinese Patent Application No. 202411981767.7, filed on Dec. 31, 2024, the entire contents of which are incorporated herein by reference.

### TECHNICAL FIELD

The present disclosure relates to the technical field of geohazard prevention and control and hydrogeological simulation, and in particular, to a numerical simulation method for rainfall-induced flash flood and debris flow.

### BACKGROUND

Flash flood and debris flow is a serious natural disaster, which poses a great threat to the safety of human life and property and the ecological environment. Accurately simulating the occurrence and development process of the flash flood and debris flow is of great significance for early warning, disaster prevention and mitigation, and risk management. In recent years, with an in-depth study of the occurrence mechanism of the flash flood and debris flow, it is gradually recognized that rainfall conditions have an important impact on the occurrence and development process of the flash flood and debris flow. Factors such as rainfall intensity, rainfall duration, rainfall distribution, etc. affect the initiation, movement, and deposition process of the flash flood and debris flow. However, most of the existing numerical simulation methods for the flash flood and debris flow do not fully consider the influence of vegetation conditions and sand transport process, which leads to a large deviation between simulation results and actual situation.

### SUMMARY

The purpose of the present disclosure is to provide a numerical simulation method for rainfall-induced flash flood and debris flow, solving the problem that most of the existing numerical simulation methods for the flash flood and debris flow do not fully consider the influence of vegetation conditions and sand transport process, which leads to a large deviation between simulation results and actual situation.

One of the embodiments of the present disclosure provides a numerical simulation method for rainfall-induced flash flood and debris flow, comprising: obtaining, based on a continuum medium mechanics manner coupled with a hydrodynamic model of a three-phase medium of water, coarse particles, and fine particles, data required for the numerical simulation method, the data including at least one of topographical data, temporal data of rainfall, vegetation distribution data, a volume content of initial coarse particles of a torrent bed, and a volume content of initial fine particles of the torrent bed.

In some embodiments, governing equations of the hydrodynamic model are:

$$\frac{\partial ( h )}{\partial t} + \frac{\partial ( hu )}{\partial x} + \frac{\partial ( hv )}{\partial y} = {R}_{e} - I + E - D$$

$$\frac{\partial p}{\partial t} + \frac{\partial }{\partial x} ( \frac{{p}^{2}}{h} ) + \frac{\partial }{\partial y} ( \frac{pq}{h} ) = - gh \frac{\partial ( h + {z}_{b} )}{\partial x} - \frac{{τ}_{bx}}{ρ} - ( {R}_{e} - I + E - D ) \frac{p}{h}$$

$$\frac{\partial q}{\partial t} + \frac{\partial }{\partial x} ( \frac{pq}{h} ) + \frac{\partial }{\partial y} ( \frac{{q}^{2}}{h} ) = - gh \frac{\partial ( h + {z}_{b} )}{\partial y} - \frac{{τ}_{by}}{ρ} - ( {R}_{e} - I + E - D ) \frac{q}{h}$$

wherein h denotes a flow depth of the flash flood and debris flow, united in m; p=hu denotes a discharge per unit width of the flash flood and debris flow along an x-direction, united in m²/s; q=hv denotes a discharge per unit width of the flash flood and debris flow along a y-direction, united in m²/s; u denotes a velocity of the flash flood and debris flow along the x-direction, united in m/s; v denotes a velocity of the flash flood and debris flow along the y-direction, united in m/s; ρ=c_{w}ρ_{w}+(c_{f}+c_{c})ρₛ denotes a density of the flash flood and debris flow, united in kg/m³; c_{w} denotes a volumetric concentration of water in the flash flood and debris flow, expressed in dimensionless units; c_{c} denotes volumetric concentration of coarse particles in the flash flood and debris flow, expressed in dimensionless units; c_{f} denotes volumetric concentration of fine particles in the flash flood and debris flow, expressed in dimensionless units; ρₛ=2650 denotes an intrinsic density of particles in the flash flood and debris flow, united in kg/m³; ρ_{w}=1000 denotes a density of the clear water, united in kg/m³; τ_{bx} denotes a bottom-bed resistance of the flash flood and debris flow along the x-direction, united in Pa; τ_{by} denotes a bottom-bed resistance of the flash flood and debris flow along the y-direction, united in Pa; z_{b} denotes an elevation of terrain required for the numerical simulation method, united in m; g=9.81 denotes a gravitational acceleration, united in m/s²; Rₑ denotes an effective rainfall intensity, united in m/s; I denotes a soil infiltration rate, united in m/s; E=E_{w}+E_{f}+E_{c} denotes a total erosion rate of the flash flood and debris flow, united in m/s; E_{w} denotes an erosion rate of the water during the movement of the flash flood and debris flow, united in m/s; E_{c} denotes an erosion rate of coarse particles during the movement of the flash flood and debris flow, united in m/s; E_{f} denotes an erosion rate of fine particles during the movement of the flash flood and debris flow, united in m/s; D=D_{f}+D_{c} denotes total deposition rate of the particles in the flash flood and debris flow, united in m/s; D_{f} denotes a deposition rate of fine particles in the flash flood and debris flow, united in m/s; D_{c} denotes a deposition rate of coarse particles in the flash flood and debris flow, united in m/s; t denotes time, united in s.

In some embodiments, transport equations for the water, the fine particles, and the coarse particles in the flash flood and debris flow are as follows:

$$\frac{\partial ( {hc}_{w} )}{\partial t} + \frac{\partial ( {c}_{w} hu )}{\partial x} + \frac{\partial {c}_{w} hv}{\partial y} = {R}_{e} - I + {E}_{w}$$

$$\frac{\partial {hc}_{f}}{\partial t} + \frac{\partial ( {huc}_{f} )}{\partial x} + \frac{\partial ( {hvc}_{f} )}{\partial y} = \frac{\partial }{\partial x} ( h {ε}_{f} \frac{\partial {c}_{f}}{\partial x} ) + \frac{\partial }{\partial y} ( h {ε}_{f} \frac{\partial {c}_{f}}{\partial y} ) + {E}_{f} - {D}_{f}$$

$$\frac{\partial ( {hc}_{c} )}{\partial t} + \frac{\partial ( {huc}_{c} )}{\partial x} + \frac{\partial ( {hvc}_{c} )}{\partial y} = {E}_{c} - {D}_{c}$$

wherein h denotes the flow depth of the flash flood and debris flow, united in m; u denotes the velocity of the flash flood and debris flow along the x-direction, united in m/s; v denotes the velocity of the flash flood and debris flow along the y-direction, united in m/s; c_{w} denotes the volumetric concentration of the water in the flash flood and debris flow, expressed in dimensionless units; c_{c} denotes the volumetric concentration of the coarse particles in the flash flood and debris flow, expressed in dimensionless units; c_{f} denotes the volumetric concentration of the fine particles in the flash flood and debris flow, expressed in dimensionless units; Rₑ denotes the effective rainfall intensity, united in m/s; I denotes the soil infiltration rate, united in m/s; E_{w} denotes the erosion rate of the water during the movement of the flash flood and debris flow, united in m/s; E_{c} denotes the erosion rate of the coarse particles during the movement of the flash flood and debris flow, united in m/s; E_{f} denotes the erosion rate of the fine particles during the movement of the flash flood and debris flow, united in m/s; D_{f} denotes the deposition rate of the fine particles in the flash flood and debris flow, united in m/s; D_{c} denotes the deposition rate of the coarse particles in the flash flood and debris flow, united in m/s; ε_{f} denotes a diffusion coefficient of the fine particles in the flash flood and debris flow, united in m²/s; t denotes the time united in s; and/or

an evolutionary equation for the terrain is:

$$( 1 - {λ}_{p} ) \frac{\partial {z}_{b}}{\partial t} = - \frac{\partial {q}_{bx}}{\partial x} - \frac{\partial {q}_{by}}{\partial y} + D - E$$

wherein, λₚ denotes bed porosity, expressed in dimensionless units; z_{b} denotes the elevation of the terrain required for the numerical simulation method, united in m; E=E_{w}+E_{f}+E_{c} denotes the total erosion rate of the flash flood and debris flow, united in m/s; E_{w} denotes the erosion rate of the water during the movement of the flash flood and debris flow, united in m/s; E_{c} denotes the erosion rate of the coarse particles during the movement of the flash flood and debris flow united in m/s; E_{f} denotes the erosion rate of the fine particles during the movement of the flash flood and debris flow, united in m/s; D=D_{f}+D_{c} denotes the total deposition rate of the particles in the flash flood and debris flow, united in m/s; D_{f} denotes the deposition rate of the fine particles in the flash flood and debris flow, united in m/s; D_{c} denotes the deposition rate of the coarse particles in the flash flood and debris flow, united in m/s; q_{bx} denotes bed load transport rate per unit width along the x-direction, united in m²/s; q_{by} denotes bed load transport rate per unit width along the y-direction, united in m²/s; t denotes the time, united in s.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating a particle size distribution curve of debris flow according to some embodiments of the present disclosure; and

FIG. 2 is a schematic diagram illustrating simulation results of formation and movement of flash flood and debris flow in a ditch in Sichuan under rainfall conditions according to some embodiments of the present disclosure.

### DETAILED DESCRIPTION

The accompanying drawings, which are required to be used in the description of the embodiments, are briefly described below. The accompanying drawings do not represent the entirety of the embodiments.

Unless the context clearly suggests an exception, the words “one,” “a,” “an,” and/or “the” do not refer specifically to the singular, but may also include the plural. Generally, the terms “including” and “comprising” only suggest the inclusion of explicitly identified steps and elements that do not constitute an exclusive list, and the method or apparatus may also include other steps or elements.

In some embodiments, a numerical simulation method for rainfall-induced flash flood and debris flow includes: obtaining a rainfall amount, a ground slope, and a soil density by an environmental monitoring device and determining a flash flood risk value based on the rainfall amount, the ground slope, and the soil density; in response to determining that the flash flood risk value satisfies a predetermined risk condition, obtaining a simulation result by performing a simulation based on the numerical simulation method based on a plurality of equations; determining a digging location of a digging robot and a digging depth of the digging location based on the simulation result; and generating, based on the digging location and the digging depth, controlling instructions to drive the digging robot to move to the digging location and cut a bucket into a soil layer by a servomotor to excavate a drainage trench with the corresponding digging depth.

The environmental monitoring device refers to an instrument or equipment used to collect, record, and analyze environmental parameters, such as a rain gauge, a laser slope scanner, a time-domain reflectometer, a pressure sensor, or the like. The environmental parameters include a rainfall amount, a ground slope, and a soil density.

The rainfall amount refers to a total amount of rainwater that falls to the ground in a given period of time (e.g., hours, days, or months). The rainfall amount may be obtained from the rain gauge. The rain gauge includes a tipping bucket rain gauge, a weighing rain gauge, or the like.

The ground slope refers to a degree of inclination of surface of the earth relative to a horizontal plane, usually expressed in terms of an angle of slope or a percentage of slope. The ground slope may be obtained with a laser slope scanner. The ground slopes may also be obtained in any other feasible way, e.g., by digital elevation modeling (DEM), etc.

The soil density refers to a mass per unit volume of soil. In some embodiments, the soil density may be obtained by a combination of the time-domain reflectometer and the pressure sensor measurements.

The flash flood risk value refers to data used to measure likelihood of the flash flood and debris flow occurring. In some embodiments, the flash flood risk value may be determined in a plurality of ways based on the rainfall amount, the ground slope, and the soil density. For example, the flash flood risk value is determined by consulting a risk table. The risk table refers to a table that includes a correspondence between the rainfall amount, the ground slope, the soil density, and the flash flood risk value. The risk table may be obtained based on historical data. Merely by way of example, a historical rainfall amount, a historical ground slope, and a historical soil density corresponding to a historical flash flood risk value may be counted, and the historical rainfall amount, the historical ground slope, and the historical soil density with the most occurrences may be counted in the risk table. The risk table may be obtained by repeating the preceding operation several times.

The predetermined risk condition refers to a predetermined judgment condition related to the flash flood risk value. For example, the predetermined risk condition includes the flash flood risk value being higher than a risk threshold.

The risk threshold refers to a threshold value used to determine whether the flash flood risk value reaches a critical value that requires response measures.

The predetermined risk condition and the risk threshold may be set based on actual needs.

In some embodiments, the simulation result includes a flow depth distribution, a velocity distribution, a first volumetric concentration distribution, and a second volumetric concentration distribution.

The flow depth distribution refers to a distribution of flow depths of the flash flood and debris flow at different spatial locations, i.e., a vertical height of debris flow fluid above the surface of the earth. The flow depth distribution may also be referred to as a flow depth distribution of the flash flood and debris flow. In some embodiments, the flow depth distribution may be obtained by counting the flow depths of the flash flood and debris flow at different locations.

The velocity distribution refers to a distribution of flow velocities of the flash flood and debris flow at different spatial locations, i.e., a distance that the debris flow fluid moves per unit of time. The velocity distribution may also be referred to as a velocity distribution of the flash flood and debris flow. In some embodiments, the velocity distribution may be obtained by counting the flow velocities of the flash flood and debris flow along different directions.

The first volumetric concentration distribution refers to a change condition in a volume share of coarse particles in the fluid in flash flood or debris flow over time or spatial location. The first volumetric concentration distribution may also be referred to as a distribution of volumetric concentration of coarse particles in the flash flood and debris flow. In some embodiments, the first volumetric concentration distribution may be obtained by counting the volumetric concentration of the coarse particles in the flash flood and debris flow at different locations.

The second volumetric concentration distribution refers to a change condition in a volume share of fine particles in the fluid in the flash flood or the debris flow over time or spatial location. The second volumetric concentration distribution may also be referred to as a distribution of volumetric concentration of fine particles in the flash flood and debris flow. In some embodiments, the second volumetric concentration distribution may be obtained by counting the volumetric concentration of the fine particles in the flash flood and debris flow at different locations.

In some embodiments, the simulation result may be obtained by performing a simulation based on the numerical simulation method. More details regarding the numerical simulation method may be found in the later description.

The plurality of equations include governing equations, transport equations, and an evolutionary equation. More details regarding the governing equations, the transport equations, and the evolutionary equation may be found in the later description.

The digging robot is an automated or semi-automated mechanical device used to perform digging tasks, usually combining components such as a robotic arm, a bucket, and a sensor. The robotic arm includes a plurality of joints and linkages, and each of the plurality of joints is equipped with a servomotor for controlling the movement of the robotic arm. The bucket refers to a tool mounted at an end of the robotic arm for digging, shoveling, or guiding rows; a size of the bucket may be set based on actual needs. The sensor includes a positioning sensor, a depth sensor, or the like. The positioning sensor is used to determine the digging location of the digging robot; the depth sensor is used to measure the digging depth.

In some embodiments, based on the simulation result, the digging location and the digging depth may be determined in a plurality of ways. For example, the digging location may be determined by the following operations: based on the first volumetric concentration distribution and the second volumetric concentration distribution in the simulation result, determining a potential object source region and a potential main flow channel; and identifying the potential object source region and the potential main flow channel as the digging location. The potential source region refers to a region that the volumetric concentration of at least one of the fine particles or the coarse particles satisfies a first predetermined condition. The first predetermined condition may be that the volumetric concentration of at least one of the fine particles or the coarse particles is greater than a concentration threshold. The potential main flow channel refers to a region that at least one of the flow depth or the velocity of the fluid satisfies a second predetermined condition. The second predetermined condition may be that at least one of the flow depth or the velocity of the fluid is greater than a predetermined threshold. The first predetermined condition, the concentration threshold, the second predetermined condition, and the predetermined threshold may be set based on actual needs. The digging depth may be determined by the following operations: for the digging location of the potential source region, determining the digging depth based on peak concentration of the digging location; and for the digging location corresponding to the potential main flow channel, determining the digging depth based on a peak flow depth and a peak flow depth of the digging location. The peak concentration refers to a maximum value of the volumetric concentration at least one of the fine particles or the coarse particles in the flash flood and debris flow at a particular time period. The peak concentration may be obtained by curve fitting at least one of the first volumetric concentration distribution or the second volumetric concentration distribution. The horizontal coordinate of the curve is time and the vertical coordinate is the volumetric concentration. The peak flow depth and the peak velocity refer to maximum values of the flow depth and the velocity of the fluid, respectively, in the flash flood and debris flow at a particular time period. The peak flow depth and the peak velocity are obtained in a similar way to the peak concentration, with the difference being that the vertical coordinates of the curves are the flow depth and the velocity of the flash flood and debris flow, respectively.

The peak concentration is proportional to the digging depth. When the peak concentration is determined, the digging depth may be determined by querying a first correspondence table. The first correspondence table refers to a table including a correspondence between the peak concentration and the digging depth.

The peak flow depth and the peak velocity are also directly proportional to the digging depth. After the peak flow depth and the peak velocity are determined, the digging depth may be determined by querying a second correspondence table. The second correspondence table refers to a table including a correspondence between the peak flow depth, the peak velocity, and the digging depth.

The process of constructing the first correspondence table and the second correspondence table is similar to the process of constructing the risk table, which may be found in the previous descriptions.

The control instructions refer to instructions related to controlling the work of the digging robot.

The drainage trench refers to a man-made trench used to direct and channel the debris flows, floods, or other surface runoff.

In some embodiments, in response to the digging robot receiving the control instructions, the digging robot moves to the digging location and cuts the bucket into the soil layer by the servomotor to dig the drainage trench corresponding to the digging depth.

In some embodiments of the present disclosure, by designing a linkage system that combines with actuality, actuality and simulation are combined, which is conducive to improving the accuracy of early warning and control of the flash flood and debris flow disaster, and to reducing the cost and risk of disaster prevention and control.

The technical solution of the present disclosure is as follows.

Embodiments of the present disclosure provide a numerical simulation method for rainfall-induced flash flood and debris flow, including: obtaining, based on a continuum medium mechanics manner coupled with a hydrodynamic model of a three-phase medium of water, coarse particles, and fine particles, data required for the numerical simulation method, the data includes at least one of topographical data, temporal data of rainfall, vegetation distribution data, a volume content of initial coarse particles of a torrent bed, and a volume content of initial fine particles of the torrent bed.

In some embodiments, governing equations of the hydrodynamic model are:

$$\frac{\partial ( h )}{\partial t} + \frac{\partial ( h u )}{\partial x} + \frac{\partial ( h v )}{\partial y} = {R}_{e} - I + E - D \qquad ( 1 )$$

$$\frac{\partial p}{\partial t} + \frac{\partial }{\partial x} ( \frac{{p}^{2}}{h} ) + \frac{\partial }{\partial y} ( \frac{p q}{h} ) = - g h \frac{\partial ( h + {z}_{b} )}{\partial x} - \frac{{τ}_{b x}}{ρ} - ( {R}_{e} - I + E - D ) \frac{p}{h} \qquad ( 2 )$$

$$\frac{\partial q}{\partial t} + \frac{\partial }{\partial x} ( \frac{p q}{h} ) + \frac{\partial }{\partial y} ( \frac{{q}^{2}}{h} ) = - gh \frac{\partial ( h + {z}_{b} )}{\partial y} - \frac{{τ}_{by}}{ρ} - ( {R}_{e} - I + E - D ) \frac{q}{h} \qquad ( 3 )$$

wherein h denotes a flow depth of the flash flood and debris flow, united in m; p=hu denotes a discharge per unit width of the flash flood and debris flow along an x-direction, united in m²/s; q=hv denotes a discharge per unit width of the flash flood and debris flow along a y-direction, united in m²/s; u denotes a velocity of the flash flood and debris flow along the x-direction, united in m/s; v denotes a velocity of the flash flood and debris flow along the y-direction, united in m/s; ρ=c_{w}ρ_{w}+(c_{f}+c_{c})ρₛ denotes a density of the flash flood and debris flow, united in kg/m³; c_{w} denotes a volumetric concentration of water in the flash flood and debris flow, expressed in dimensionless units; c_{c} denotes volumetric concentration of coarse particles in the flash flood and debris flow, expressed in dimensionless units; c_{f} denotes volumetric concentration of fine particles in the flash flood and debris flow, expressed in dimensionless units; ρₛ=2650 denotes an intrinsic density of particles in the flash flood and debris flow, united in kg/m³; ρ_{w}=1000 denotes a density of the clear water, united in kg/m³; τ_{bx} denotes a bottom-bed resistance of the flash flood and debris flow along the x-direction, united in Pa; τ_{by} denotes a bottom-bed resistance of the flash flood and debris flow along the y-direction, united in Pa; z_{b} denotes an elevation of terrain required for the numerical simulation method, united in m; g=9.81 denotes a gravitational acceleration, united in m/s²; Rₑ denotes an effective rainfall intensity, united in m/s; I denotes a soil infiltration rate, united in m/s; E=E_{w}+E_{f}+E_{c} denotes a total erosion rate of the flash flood and debris flow, united in m/s; E_{w} denotes an erosion rate of the water during the movement of the flash flood and debris flow, united in m/s; E_{c} denotes an erosion rate of coarse particles during the movement of the flash flood and debris flow, united in m/s; E_{f} denotes an erosion rate of fine particles during the movement of the flash flood and debris flow, united in m/s; D=D_{f}+D_{c} denotes total deposition rate of the particles in the flash flood and debris flow, united in m/s; D_{f} denotes a deposition rate of fine particles in the flash flood and debris flow, united in m/s; D_{c} denotes a deposition rate of coarse particles in the flash flood and debris flow, united in m/s; t denotes time, united in s.

In some embodiments, transport equations for the water, the fine particles, and the coarse particles in the flash flood and debris flow are as follows:

$$\frac{\partial ( h {c}_{w} )}{\partial t} + \frac{\partial ( {c}_{w} h u )}{\partial x} + \frac{\partial ( {c}_{w} h v )}{\partial y} = {R}_{e} - I + {E}_{w} \qquad ( 4 )$$

$$\frac{\partial {hc}_{f}}{\partial t} + \frac{\partial ( h u {c}_{f} )}{\partial x} + \frac{\partial ( h v {c}_{f} )}{\partial y} = \frac{\partial }{\partial x} ( h {ε}_{f} \frac{\partial {c}_{f}}{\partial x} ) + \frac{\partial }{\partial y} ( h {ε}_{f} \frac{\partial {c}_{f}}{\partial y} ) + {E}_{f} - {D}_{f} \qquad ( 5 )$$

$$\frac{\partial ( {hc}_{c} )}{\partial t} + \frac{\partial ( h u {c}_{c} )}{\partial x} + \frac{\partial ( h v {c}_{c} )}{\partial y} = {E}_{c} - {D}_{c} \qquad ( 6 )$$

wherein h denotes the flow depth of the flash flood and debris flow, united in m; u denotes the velocity of the flash flood and debris flow along the x-direction, united in m/s; v denotes the velocity of the flash flood and debris flow along the y-direction, united in m/s; c_{w} denotes the volumetric concentration of the water in the flash flood and debris flow, expressed in dimensionless units; c_{c} denotes the volumetric concentration of the coarse particles in the flash flood and debris flow, expressed in dimensionless units; c_{f} denotes the volumetric concentration of the fine particles in the flash flood and debris flow, expressed in dimensionless units; Rₑ denotes the effective rainfall intensity, united in m/s; I denotes the soil infiltration rate, united in m/s; E_{w} denotes the erosion rate of the water during the movement of the flash flood and debris flow, united in m/s; E_{c} denotes the erosion rate of the coarse particles during the movement of the flash flood and debris flow, united in m/s; E_{f} denotes the erosion rate of the fine particles during the movement of the flash flood and debris flow, united in m/s; D_{f} denotes the deposition rate of the fine particles in the flash flood and debris flow, united in m/s; D_{c} denotes the deposition rate of the coarse particles in the flash flood and debris flow, united in m/s; ε_{f} denotes a diffusion coefficient of the fine particles in the flash flood and debris flow, united in m²/s; t denotes the time united in s.

In some embodiments, an evolutionary equation for the terrain is:

$$( 1 - {λ}_{p} ) \frac{\partial {z}_{b}}{\partial t} = - \frac{\partial {q}_{b x}}{\partial x} - \frac{\partial {q}_{by}}{\partial y} + D - E \qquad ( 7 )$$

wherein, λₚ denotes bed porosity, expressed in dimensionless units; z_{b} denotes the elevation of the terrain required for the numerical simulation method, united in m; E=E_{w}+E_{f}+E_{c} denotes the total erosion rate of the flash flood and debris flow, united in m/s; E_{w} denotes the erosion rate of the water during the movement of the flash flood and debris flow, united in m/s; E_{c} denotes the erosion rate of the coarse particles during the movement of the flash flood and debris flow united in m/s; E_{f} denotes the erosion rate of the fine particles during the movement of the flash flood and debris flow, united in m/s; D=D_{f}+D_{c} denotes the total deposition rate of the particles in the flash flood and debris flow, united in m/s; D_{f} denotes the deposition rate of the fine particles in the flash flood and debris flow, united in m/s; D_{c} denotes the deposition rate of the coarse particles in the flash flood and debris flow, united in m/s; q_{bx} denotes bed load transport rate per unit width along the x-direction, united in m²/s; q_{by} denotes bed load transport rate per unit width along the y-direction, united in m²/s; t denotes the time, united in s.

The continuum medium mechanics manner is a theoretical framework for the study of the motion and deformation of matter on macroscopic scales, which assumes that the matter is continuously distributed rather than composed of discrete particles.

The coarse particles and the fine particles refer to two types of solids that are categorized based on particle size. When the particle size of a particle is larger than a particle size threshold, the particle is the coarse particle; when the particle size of a particle is smaller than the particle size threshold, the particle is the fine particle. The particle size threshold may include a plurality of values, such as, 2 mm, 3 mm, or the like. The particle size threshold may be set based on actual needs.

The hydrodynamic model refers to a model that simplifies and abstracts fluid motion. For example, the hydrodynamic model includes a continuous medium model, an ideal fluid model, an incompressible fluid model, or the like.

The topographical data refers to spatial data describing the morphology and characteristics of the ground surface. For example, the topographical data includes an elevation (altitude) surface of the earth slope, a slope direction, and topographic relief of the surface of the earth. The elevation refers to a height of each point on the surface of the earth relative to a datum (e.g., sea level); the slope refers to a degree of inclination of the surface of the earth at a certain location, usually expressed as an angle or a percentage; the slope direction refers to a direction in which the surface of the earth is inclined at a certain location, usually expressed as an angle (0° to 360°); and the topographic relief refers to a change in elevation characteristics of the surface of the earth such as peaks, valleys, and plains.

In some embodiments, the topographical data may be obtained in a plurality of ways. For example, the topographical data may be obtained through remote sensing. Exemplary remote sensing techniques include LiDAR, satellite imagery, or the like. As another example, the topographical data may be obtained through field surveys.

The temporal data of rainfall refers to data that records rainfall over time within a certain time frame. For example, the temporal data of rainfall includes a time point of the rainfall, the rainfall amount, an intensity of the rainfall, a type of the rainfall, or the like. The time point of the rainfall refers to a time interval at which the rainfall is recorded, e.g., minutes, hours, etc.; the intensity of the rainfall refers to the rainfall amount per unit of time, representing a velocity of the rainfall; and the type of the rainfall includes light rain, moderate rain, heavy rain, etc.

In some embodiments, the temporal data of rainfall may be obtained in a plurality of ways. For example, the temporal data of rainfall may be obtained through weather station observations. As another example, the temporal data of rainfall may be obtained by rain gauge measurements.

The vegetation distribution data refers to data related to distribution characteristics of vegetation on surface of the earth. For example, the vegetation distribution data includes a vegetation type, a vegetation coverage, a vegetation density, or the like. For example, the vegetation type includes forest, grassland, wetland, etc.; the vegetation coverage refers to a proportion of the vegetation covering the surface of the earth, which is usually expressed as a percentage; and the vegetation density refers to a count or biomass of the vegetation per unit area.

In some embodiments, the vegetation distribution data may be obtained in a plurality of ways. For example, the vegetation distribution data may be obtained through remote sensing. As another example, the vegetation distribution data may be obtained through ground-based observations.

The torrent bed is a bottom of gully or ravine, which is a landform shaped by water erosion and deposition.

The initial coarse particles refers to solid matter with a relatively large particle size (greater than a particle size threshold), including gravel, cobble, and crushed stone, that is present in the watershed or in the source region of the potential debris flow prior to the occurrence of the debris flow. The initial fine particles refers to solid matter with a relatively small particle size (less than the particle size threshold), including silt, clay, etc., that is present in the watershed or in the source region of the potential debris flow prior to the occurrence of the debris flow.

The volume content refers to a proportion of volume that a substance occupies in a mixture or composite, usually expressed as a percentage or decimal.

In some embodiments, the volume content may be obtained in a plurality of ways. For example, the volume content may be obtained by direct measurement. As another example, the volume content may be extrapolated by an indirect measurement approach.

The flow depth of the flash flood and debris flow refers to a vertical depth of the flash flood or the debris flow at a cross-section or at a location where its fluids (including water, sediment, rocks, etc.) are present during the flow.

The x-direction refers to a main direction of flow of the flash flood and debris flow along a mountain or river channel. The y-direction refers to a lateral direction perpendicular to the main direction (i.e., the x-direction).

The discharge per unit width refers to a flow rate of the debris flow passing over a unit width (e.g., 1 meter) and is commonly used to describe the distribution of flow in a certain cross-section of fluid, such as river, ditch, or the debris flow.

The density of the flash flood and debris flow refers to a parameter that describes a mass distribution of a mixture of solid matter (e.g., sediment, rocks, etc.) and fluid (e.g., water) in the flash flood and debris flow.

The volumetric concentration refers to a proportion of volume that a substance occupies in a mixture, usually expressed as a percentage or decimal. The volumetric concentration may also be referred to as a volumetric fraction.

The particles refers to a collection of matter including a large number of discrete solid particles. In some embodiments, the particles includes the fine particles and the coarse particles. The coarse particles refers to solid particles in the debris flow or the flash flood that are larger in size and have a particle size greater than a particle size threshold, and the fine particles refers to solid particles in the debris flow or the flash flood that are smaller in size and have a particle size less than the particle size threshold. In some embodiments, the coarse particles may also be referred to as coarse particles sediment and the fine particles may also be referred to as fine particles sediment.

The bottom-bed resistance refers to a force that impedes the flow of fluid (e.g., water, the debris flow, etc.) due to contact with the bottom during flow.

In some embodiments, in the governing equations, the bottom-bed resistance of the flash flood and debris flow along the x-direction ρ_{bx} and the bottom-bed resistance of the flash flood and debris flow along the y-direction t are calculated by:

$${τ}_{b x} = \frac{ρ {gn}^{2} p \sqrt{{p}^{2} + {q}^{2}}}{{h}^{7 / 3}} Γ + [ ( {c}_{f} + {c}_{w} ) {τ}_{fx} + {c}_{c} {τ}_{c x} ] ( 1 - Γ ) \qquad ( 8 )$$

$${τ}_{b y} = \frac{ρ {gn}^{2} p \sqrt{{p}^{2} + {q}^{2}}}{{h}^{7 / 3}} Γ + [ ( {c}_{f} + {c}_{w} ) {τ}_{fy} + {c}_{c} {τ}_{cy} ] ( 1 - Γ ) \qquad ( 9 )$$

wherein ρ=c_{w}ρ_{w}+ (c_{f}+c_{c})ρₛ denotes the density of the flash flood and debris flow, united in kg/m³; c_{w} denotes the volumetric concentration of the water in the flash flood and debris flow, expressed in dimensionless units; c_{c} denotes the volumetric concentration of the coarse particles in the flash flood and debris flow, expressed in dimensionless units; c_{f} denotes the volumetric concentration of the fine particles in the flash flood and debris flow, expressed in dimensionless units; ρₛ=2650 denotes the intrinsic density of the particles in the flash flood and debris flow, united in kg/m³; ρ_{w}=1000 denotes the density of the clear water, united in kg/m³; n denotes an roughness coefficient in the flash flood and debris flow, united in s/m^{1/3}; h denotes the flow depth of the flash flood and debris flow, united in m; p=hu denotes the discharge per unit width of the flash flood and debris flow along the x-direction, united in m²/s; q=hv denotes the discharge per unit width of the flash flood and debris flow along the y-direction, united in m²/s; u denotes the velocity of the flash flood and debris flow along the x-direction, united in m/s; v denotes the velocity of the flash flood and debris flow along the y-direction, united in m/s; Γ denotes the transition factor from the flash flood to the debris flow, expressed in dimensionless units; τ_{fx} and τ_{fy} denote bottom-bed resistances of liquid-phase mudflow of the flash flood and debris flow along the x-direction and the y-direction, respectively, united in Pa; τ_{cx} and τ_{cy} denote bottom-bed resistances of the coarse particles in the flash flood and debris flow along the x-direction and the y-direction, respectively, united in Pa; g=9.81 denotes the gravitational acceleration, united in m/s².

In some embodiments, the bottom-bed resistance of the liquid-phase slurry of the flash flood and debris flow along the x-direction τ_{fx} and the bottom-bed resistance of the liquid-phase mudflow of the flash flood and debris flow along the y-direction τ_{fy} are calculated by following equations, respectively:

$${τ}_{fx} = 0.0 \; 98 exp ( 8.45 \frac{{S}_{v} - {S}_{v 0}}{{S}_{v m}} + 1.5 ) + 3 {{μ}_{0} ( 1 - {k}_{0} \frac{{S}_{v}}{{S}_{v m}} )}^{- 2.5} \frac{u}{h} \qquad ( 10 )$$

$${τ}_{fy} = 0.0 \; 98 exp ( 8.45 \frac{{S}_{v} - {S}_{v 0}}{{S}_{v m}} + 1.5 ) + 3 {{μ}_{0} ( 1 - {k}_{0} \frac{{S}_{v}}{{S}_{v m}} )}^{- 2.5} \frac{v}{h} \qquad ( 11 )$$

wherein h denotes the flow depth of the flash flood and debris flow, united in m; u denotes the velocity of the flash flood and debris flow along the x-direction, united in m/s; v the velocity of the flash flood and debris flow along the y-direction, united in m/s; μ₀=10⁻³ denotes a kinetic viscosity of water united in Pa·s;

$${S}_{v} = \frac{{c}_{f}}{1 - {c}_{c}}$$

denotes volumetric concentration of the fine particles in the liquid slurry expressed in dimensionless units.

Sᵥₘ denotes maximum permissible volumetric concentration of the fine particles in the liquid slurry, expressed in dimensionless units, which is calculated by following formula:

$${S}_{v m} = 0.92 - 0.2 {log}_{10} ( \sum \frac{{p}_{i}}{{d}_{i}} ) \qquad ( 12 )$$

wherein dᵢ denotes a diameter of an ith particle size class in the fine particles sediment, expressed in mm; and pᵢ denotes a mass percentage of the ith particle size class in the fine particles sediment, expressed in dimensionless units.

Sᵥ₀ denotes critical volumetric concentration of a fluid for a transition from a Newtonian fluid to a Bingham fluid, expressed in dimensionless units, which is calculated by:

$${S}_{v 0} = 1 \text{.26} {S}_{v m}^{3.2} \qquad ( 13 )$$

k₀ denotes a correction coefficient, expressed in dimensionless units, which is expressed by:

$${k}_{0} = 1 + 2 {( \frac{{s}_{v}}{{s}_{v m}} )}^{0.3} {( 1 - \frac{{s}_{v}}{{s}_{v m}} )}^{4} \qquad ( 14 )$$

In some embodiments, the bottom-bed resistance of the coarse particles along the x-direction τ_{cx} and the bottom-bed resistance of the coarse particles along the y-direction τ_{cy} in the flash flood and debris flow are calculated by following formulas, respectively:

$${τ}_{c x} = ( ρ - {ρ}_{f} ) g h cos {θ}_{x} tan {φ}_{s} \frac{p}{\sqrt{{p}^{2} + {q}^{2}}} + {c}_{c} {ρ}_{s} g \frac{p \sqrt{{p}^{2} + {q}^{2}}}{{h}^{2} {C}_{z}^{2}} \qquad ( 15 )$$

$${τ}_{cy} = ( ρ - {ρ}_{f} ) g h cos {θ}_{y} tan {φ}_{s} \frac{q}{\sqrt{{p}^{2} + {q}^{2}}} + {c}_{c} {ρ}_{s} g \frac{q \sqrt{{p}^{2} + {q}^{2}}}{{h}^{2} {C}_{z}^{2}} \qquad ( 16 )$$

wherein τ_{cx} denotes the bottom-bed resistance of the coarse particles along the x-direction in the flash flood and debris flow, united in Pa; τ_{cy} denotes the bottom-bed resistance of the coarse particles along the y-direction in the flash flood and debris flow, united in Pa; ρ=c_{w}ρ_{w}+(c_{f}+c_{c})ρₛ denotes the density of the flash flood and debris flow, united in kg/m³;

$${ρ}_{f} = \frac{1}{1 - {c}_{c}} \{ {ρ}_{s} {c}_{f} + {ρ}_{w} [ 1 - ( {c}_{f} + {c}_{c} ) ] \}$$

denotes density of liquid-phase mudflow consisting of the fine particles and the water, united in kg/m³; c_{w} denotes the volumetric concentration of the water in the flash flood and debris flow, expressed in dimensionless units; c_{c} denotes the volumetric concentration of the coarse particles in the flash flood and debris flow, expressed in dimensionless units; c_{f} denotes the volumetric concentration of the fine particles in the flash flood and debris flow, expressed in dimensionless units; ρₛ=2650 denotes the intrinsic density of the particles in the flash flood and debris flow, united in kg/m³; ρ_{w}=1000 denotes the density of the clear water, united in kg/m³; p=hu denotes the discharge per unit width of the flash flood and debris flow along the x-direction, united in m²/s; q=hv denotes the discharge per unit width of the flash flood and debris flow along the y-direction, united in m²/s; u denotes the velocity of the flash flood and debris flow along the x-direction, united in m/s; v denotes the velocity of the flash flood and debris flow along the y-direction, united in m/s; h denotes the flow depth of the flash flood and debris flow, united in m; θₓ denotes a slope of the bottom-bed of the flash flood and debris flow along the x-direction, calculated from the topography, united in °; θ_{y} denotes a slope of the bottom-bed of the flash flood and debris flow along the y-direction, calculated from the topography, united in °; φₛ denotes the friction angle of between the coarse particles and the bottom bed in the flash flood and debris flow, united in °; C_{z} denotes a turbulence coefficient of the coarse particles in the flash flood and debris flow, united in m^{1/2}/s; g=9.81 denotes the gravitational acceleration, united in m/s².

The roughness coefficient refers to a measure of roughness of a surface of a stream bed or a trench, which affects the velocity, flow volume, and the loss of energy from the flow of the flash flood.

The liquid-phase mudflow of the flash flood and debris flow refers to a fluid portion of the flash flood and debris flow that includes the water and the fine particles (e.g., clay, silt, etc.).

The kinetic viscosity of water refers to shear stress per unit area of the water at a unit velocity gradient.

The liquid slurry refers to a mixture of water and solid particles (such as fine sand, clay, mineral particles, etc.). The maximum permissible volumetric concentration Sᵥₘ refers to a maximum permissible volumetric concentration of the fine particles in the liquid slurry, which is usually related to the specific surface area of the particles.

The particle size class refers to different grades or categories into which the fine particles sediment is divided according to its size.

The Newtonian fluid refers to fluid with constant viscosity.

The Bingham fluid refers to a non-Newtonian fluid with a yield stress.

The critical volumetric concentration refers to a value of the concentration at which a fluid changes from the Newtonian fluid to the Bingham fluid.

The correction coefficient refers to a coefficient used to adjust the volumetric concentration to closer to actual conditions.

The bottom-bed of the flash flood and debris flow refers to the surface of the earth or the riverbed through which the flow of the flash flood or the debris flow passes during its occurrence.

The friction angle refers to an angle between the shear stress and the positive stress when the coarse particles begin to slide under shear.

The turbulence coefficient refers to a parameter that describes the intensity of turbulence (or turbulent flow) in the flow of the coarse particles.

The effective rainfall intensity refers to rainfall intensity that actually affects surface runoff, soil erosion, or other hydrologic processes over a given period of time.

The soil infiltration rate refers to a velocity at which water passes through the soil surface per unit of time.

The total erosion rate of the flash flood and debris flow refers to a velocity at which a surface or geologic body is eroded, denuded, or destroyed by the action of the flash flood and debris flow.

In some embodiments, a calculation formula for the effective rainfall intensity Rₑ in the control equation is:

$${R}_{e} = R ( 1 - {C}_{v} ) + R {T}_{c} {C}_{v} + {W}_{c} \qquad ( 17 )$$

wherein Rₑ denotes the effective rainfall intensity, united in m/s; R denotes an actual rainfall intensity, united in m/s; Cᵥ denotes a vegetation coverage, expressed in dimensionless units; T_{c} denotes a vegetation penetration coefficient, expressed in dimensionless units; W_{c} denotes a canopy drainage rate, united in m/s.

In some embodiments, a calculation formula of the canopy drainage rate W_{c} is:

$${W}_{c} = {K}_{c} {e}^{{g}_{c} ( C - S )} \qquad ( 18 )$$

wherein W_{c} denotes the canopy drainage rate, united in m/s; g_{c} denotes an attenuation coefficient of the canopy drainage rate, united in m⁻¹; S denotes total canopy water storage capacity, united in m; C denotes canopy water storage capacity at a moment t, united in m; K_{c} denotes a drainage coefficient when the canopy water storage capacity reaches the total canopy water storage capacity, united in m/s.

In some embodiments, at the moment t, a calculation equation for the canopy water storage capacity C is:

$$\frac{dC}{dt} = ( 1 - {T}_{c} ) R {C}_{v} - {W}_{c} \qquad ( 19 )$$

wherein C denotes the canopy water storage capacity at the moment t, united in m; T_{c} denotes the vegetation penetration coefficient, expressed in dimensionless units; R denotes the actual rainfall intensity, united in m/s; Cᵥ denotes the vegetation coverage, expressed in dimensionless units; W_{c} denotes the canopy drainage rate, united in m/s; t denotes the time united in s.

In some embodiments, a calculation formula of the soil infiltration rate I in the governing equations is:

$$I = {I}_{c} + ( {I}_{0} - {I}_{c} ) exp ( - kt ) \qquad ( 20 )$$

wherein I denotes the soil infiltration rate, united in m/s; I_{c} denotes a steady infiltration rate of the soil, united in m/s; I₀ denotes an initial infiltration rate of the soil, united in m/s; k denotes a constant describing an attenuation process of rainfall infiltration over time, united in s⁻¹; t denotes the time, in s.

In some embodiments, in the governing equations, the total erosion rate E of the flash flood and debris flow is calculated as follows:

$$E = Γ ( {r}_{w} + {e}_{w} ) + ( 1 - Γ ) {e}_{d} \qquad ( 21 )$$

wherein E denotes the total erosion rate of the flash flood and debris flow, united in m/s; r_{w} denotes a total sediment splash erosion rate of torrent bed materials due to the rainfall, united in m/s; e_{w} denotes a total erosion rate of torrent bed materials by the flash flood, united in m/s; e_{d} denotes the total erosion rate of the debris flow, united in m/s; Γ denotes a transition factor from the flash flood to the debris flow, expressed in dimensionless units.

A calculation formula of T is:

$$Γ = exp [ - α ( {c}_{f} + {c}_{c} ) / {c}_{g c} ] \qquad ( 22 )$$

wherein α denotes attenuation exponent, expressed in dimensionless units, with a value of 13.8; c_{c} denotes the volumetric concentration of the coarse particles in the flash flood and debris flow, expressed in dimensionless units; c_{f} denotes the volumetric concentration of the fine particles in the flash flood and debris flow, expressed in dimensionless units; c_{gc} denotes a critical total concentration at a boundary between the flash flood and the debris flow, expressed in dimensionless units, with a value of 0.18.

The actual rainfall intensity refers to a rainfall amount that falls to the surface of the earth per unit of time.

The vegetation penetration coefficient (VPC) refers to a ratio of the rainfall intercepted by the vegetation canopy during the rainfall process to the total rainfall.

In some embodiments, a process for determining the vegetation penetration coefficient includes: determining, based on a plurality of vegetation images, a plurality of horizontal distribution characteristics and a plurality of vertical distribution characteristics of a plurality of regions; determining, combined with experimental data from a plurality of experimental regions, a plurality of vegetation penetration sub-coefficients based on the plurality of horizontal distribution characteristics and vertical distribution characteristics; and determining the vegetation penetration coefficient of a target region by weighting the plurality of vegetation penetration sub-coefficients.

The vegetation images refer to images primarily featuring vegetation.

In some embodiments, the vegetation images may be obtained in a plurality of ways. For example, the vegetation images may be obtained through ground photography, remote sensing techniques, or the like.

The plurality of regions are obtained by dividing the target region by a preset size. The preset size may be set based on actual needs. The target region refers to a region where the simulation of the flash flood and debris flow is required. Understandably, the plurality of vegetation images cover the entire target region. A count of the plurality of vegetation images is set based on actual needs.

The horizontal distribution characteristics refer to degrees of shading of vegetation in a horizontal direction. The horizontal direction refers to a direction parallel to the ground, i.e., a planar direction.

The vertical distribution characteristics refer to degrees of shading of vegetation in a vertical direction. The vertical direction refers to a direction perpendicular to the ground, such as a height or depth direction. In some embodiments, a region corresponds to a horizontal distribution characteristic and a vertical distribution characteristic.

In some embodiments, based on the plurality of vegetation images, the horizontal distribution characteristics and the vertical distribution characteristics may be determined by a distribution characteristic determination model.

The distribution characteristic determination model refers to a model used to characterize the distribution of vegetation. In some embodiments, the distribution characteristic determination model is a machine learning model, e.g., a deep neural network (DNN), etc.

In some embodiments, an input to the distribution characteristic determination model includes the plurality of vegetation images, and an output includes the plurality of horizontal distribution characteristics and the plurality of vertical distribution characteristics of the plurality of regions.

In some embodiments, the distribution characteristic determination model may be obtained in a plurality of ways. For example, the distribution characteristic determination model may be acquired by training with a large number of labeled training samples, etc.

Merely by way of example, a historical vegetation image in historical data may be used as a training sample, and a historical horizontal distribution characteristic and a historical vertical distribution characteristic corresponding to the historical vegetation image may be used as a label corresponding to the training sample. The correspondence between the labels and the training samples, and the correspondence between the labels and the plurality of regions, are determined by manual labeling.

Exemplarily, a plurality of historical vegetation images are input into an initial determination model to obtain an output of the initial determination model; a loss function is constructed based on the output of the initial determination model with the historical horizontal distribution characteristics and the historical vertical distribution characteristics; based on the loss function, parameters of the initial determination model are iteratively updated; and until iteration end conditions are met, the training is completed, and a trained distribution characteristic determination model is obtained. The iteration end conditions include the loss function converging, a count of iterations reaching a threshold, or the like.

The experimental regions refer to regions that are used to conduct experiments. It is understandable that the experimental regions are several of the plurality of regions. The experimental regions may be set based on actual needs. Experiment refers to a process of determining the vegetation penetration sub-coefficient of a specific region through measurement or simulation manners.

The experimental data refers to relevant data obtained after the experiment on the experimental regions, including experimental horizontal distribution characteristics, experimental vertical distribution characteristics, horizontal distribution characteristics of an experimental preset time period, vertical distribution characteristics of the experimental preset time period, and experimental vegetation penetration sub coefficients. The horizontal distribution characteristics of the experimental preset time period, the vertical distribution characteristics of the experimental preset time period are characteristics for a preset future time period of the experimental horizontal distribution characteristics, the experimental vertical distribution characteristics.

The vegetation penetration sub-coefficients refer to refinement parameters of the vegetation penetration coefficient. It may be understood that a region corresponds to a vegetation penetration sub-coefficient.

In some embodiments, based on the plurality of horizontal distribution characteristics and the plurality of vertical distribution characteristics, combined with the experimental data from the plurality of experimental regions, the plurality of vegetation penetration sub-coefficients corresponding to the plurality of regions may be determined in a plurality of ways. For example, taking an un-experimented region as an example, by matching the horizontal distribution characteristics and the vertical distribution characteristics of the un-experimented region with the experimental horizontal distribution characteristics and the experimental vertical distribution characteristics of the plurality of experimental regions, an experimental region that matches the un-experimented region, an experimental vegetation penetration sub-coefficient of the experimental region, and a first similarity are obtained, and a vegetation penetration sub-coefficient of the un-experimented region is then determined as the product of the experimental vegetation penetration sub-coefficient of the matched experimented region and the first similarity. The first similarity refers to a degree of similarity of the horizontal distribution characteristics and the vertical distribution characteristics of the un-experimented region to the experimental horizontal distribution characteristics and the experimental vertical distribution characteristics of the experimental region. The first similarity may be expressed in a plurality of ways, such as, Euclidean distance, cosine similarity, or the like. Matching means matching the experimental region with a maximum first similarity to the un-experimented region.

In some embodiments, a process for determining a plurality of vegetation penetration sub-coefficients includes: based on current horizontal distribution characteristics and current vertical distribution characteristics, horizontal distribution characteristics and vertical distribution characteristics of the preset future time period of each of the plurality of regions, and combined with the experimental data from the plurality of experiment regions, determining the plurality of vegetation penetration sub-coefficients.

The preset future time period refers to a preset period of time in the future, e.g., 1 h or 2 h in the future.

In some embodiments, taking an un-experimented region as an example, by matching the horizontal distribution characteristics, the vertical distribution characteristics, the horizontal distribution characteristics of the preset future time period, and the vertical distribution characteristics of the preset future time period of the un-experimented region with the experimental horizontal distribution characteristics, the experimental vertical distribution characteristics, the horizontal distribution characteristics of the experimental preset time period, and the vertical distribution characteristics of the experimental preset time period of the plurality of experimental regions, the experimental region matched with the un-experimented region, the experimental vegetation penetration sub-coefficient of the experimental region, and a second similarity are obtained, and the vegetation penetration sub-coefficient of the un-experimented region is then determined as the product of the experimental vegetation penetration sub-coefficient of the matched experimented region and the second similarity. The second similarity refers to a degree of similarity of the horizontal distribution characteristics, the vertical distribution characteristics, the horizontal distribution characteristics and the vertical distribution characteristics of the preset future time period of the un-experimented region, and the experimental horizontal distribution characteristics, the experimental vertical distribution characteristics, the horizontal distribution characteristics of the experimental preset time period, and the vertical distribution characteristics of the experimental preset time period of the plurality of experimental regions.

In some embodiments, the horizontal distribution characteristics and the vertical distribution characteristics of the preset future time period for each region are determined based on weather data, the vegetation type, the current horizontal distribution characteristics, and the current vertical distribution characteristics. Exemplarily, the weather data, the vegetation type, the current horizontal distribution characteristics, and the vertical distribution characteristics are matched with historical weather data, historical vegetation type, historical horizontal distribution characteristics, and historical vertical distribution characteristics, actual horizontal distribution characteristics and actual vertical distribution characteristics corresponding to the matched historical data over a subsequent period are then used as the horizontal distribution characteristics and the vertical distribution characteristics of the preset future time period. Matching means that the weather data, the vegetation type, the current horizontal distribution characteristics, and the vertical distribution characteristics have the highest degree of similarity to the historical weather data, the historical vegetation type, the historical horizontal distribution characteristics, and the vertical distribution characteristics in the historical data.

In some embodiments of the present disclosure, when determining the vegetation penetration sub-coefficients, the influence of the weather data and the vegetation type is also taken into account, which facilitates the spatiotemporal adaptive and accurate calculation of the vegetation penetration sub-coefficients, thereby further improving the accuracy of subsequent predictions for the flash flood and debris flow.

In some embodiments, determining the vegetation penetration coefficient of the target region by weighting the plurality of vegetation penetration sub-coefficients may be realized by a plurality of ways. For example, the weight of weighting is a preset weight. The preset weight may be set based on actual needs.

In some embodiments, the weight of weighting is determined based on region criticality of each of the plurality of regions. The weight of weighting for each region is positively correlated to the region criticality of each region.

The region criticality refers to importance or influence of the region.

In some embodiments, the region criticality of each region is determined based on ground slope and soil density of the region.

Merely by way of example, the ground slope and the soil density of the region may be normalized, normalized ground slope and normalized soil density may be weighted and summed, and the weighted sum may be used as the region criticality. Normalization refers to a data preprocessing manner that transforms data to a specific range (e.g., [0,1]). There are a plurality of ways to implement the normalization, such as Min-Max normalization, fractional scaling normalization, or the like. The weight of weighting may be empirically preset.

In some embodiments of the present disclosure, the importance of different regions can be more accurately reflected by dynamically determining the degree of region criticality by the ground slope and the soil density and differentially assigning weights. For example, in slope regions/soil sparse regions prone to soil erosion, a higher criticality may facilitate subsequent targeted enhancement of protective measures.

In some embodiments of the present disclosure, by integrating the horizontal distribution characteristics and the vertical distribution characteristics of the plurality of regions, dynamically calibrating the vegetation penetration sub-coefficients based on the experimental data, and implementing non-uniform weighted aggregation, the computational accuracy and cross-scenario applicability of the vegetation penetration coefficient across the entire target region in complex terrains are significantly enhanced.

The canopy drainage rate refers to a rate that rainwater trapped by the canopy is discharged downward through structures such as foliage, branches, and other structures during rainfall.

The attenuation coefficient of the canopy drainage rate refers to data used to characterize the degree of attenuation of the canopy drainage rate over time or space.

The total canopy water storage capacity refers to a total amount of rainwater that the canopy is able to hold when it is completely wet.

The canopy water storage capacity refers to an amount of rainwater currently trapped by the canopy.

The drainage coefficient refers to a ratio of the amount of water discharged from the canopy per unit of time to the intensity of the rainfall when the canopy water storage capacity reaches the total canopy water storage capacity.

The steady infiltration rate of the soil refers to a constant value that the rate of water entering the soil reaches equilibrium when the soil surface is continuously supplied with water (e.g., rainfall).

The initial infiltration rate of the soil refers to a maximum rate of infiltration that the water begins to enter the soil surface.

The rainfall infiltration refers to a process by which precipitation (e.g., rainwater) moves from the surface into the soil. The process of attenuation refers to a gradual decrease process in the rate of infiltration of rainwater as the soil becomes progressively saturated.

The torrent bed materials refers to solid matter that accumulates in the torrent bed, including soil, silt, gravel, and rock debris.

The total sediment splash erosion rate refers to a depth of sediment splashed on the surface of the torrent bed materials due to raindrop impacts per unit of time during rainfall.

In some embodiments, in the E=Γ(r_{w}+e_{w})+(1−Γ)e_{d}, the total sediment splash erosion rate of the torrent bed materials due to the rainfall r_{w} includes two parts of an original soil sediment splash erosion rate r₀ and a splash erosion rate of deposition sediment rᵣ, i.e.

$${r}_{w} = {r}_{0} + {r}_{r} \qquad ( 23 )$$

$${r}_{0} = ( 1 - H ) a {R}_{e} \qquad ( 24 )$$

$${r}_{r} = H {a}_{r} {R}_{e} \qquad ( 25 )$$

wherein r_{w} denotes the total sediment splash erosion rate of the torrent bed materials due to the rainfall, united in m/s; r₀ denotes the original soil sediment splash erosion rate due to the rainfall, united in m/s; rᵣ denotes the splash erosion rate of the deposition sediment due to the rainfall, united in m/s; Rₑ denotes the effective rainfall intensity, united in m/s; H=min (m_{τ}/m_{τ}*, 1), which is a degree of a protective capacity of a sediment cover layer against a bed erosion, expressed in dimensionless units; m_{τ}=m_{f}+m_{c}, which is a total deposition mass on per unit area of the flash flood, united in kg/m²; m_{f} denotes a deposition mass of the fine particles of the flash flood on the per unit area, united in kg/m²; m_{c} denotes a deposition mass of the coarse particles of the flash flood on the per unit area, united in kg/m²; m_{τ}* denotes a deposition mass required to protect original soil from further erosion on the per unit area, united in kg/m²; a denotes a detachment coefficient of the original soil under raindrop impact, expressed in dimensionless units; aᵣ denotes a detachment coefficient of the sediment under the raindrop impact, expressed in dimensionless units.

The original soil sediment splash erosion rate refers to a total amount of sediment splash erosion on the soil surface due to raindrop impact.

The deposition sediment refers to solid particles that are carried by water currents and eventually deposited during the flash flood.

The splash erosion rate of the deposition sediment refers to a total amount of sediment that is splashed and migrated from the surface of the deposition sediment as a result of the impacts of water currents and raindrops during the flash flood.

The sediment refers to solid particles that are transported and deposited by natural forces such as water currents, wind, and glaciers.

The sediment cover layer refers to a layer of matter formed by the accumulation of sediment (e.g., sand, silt, clay, etc.) on the surface of streambed.

The degree of the protective capacity of the sediment cover layer against the bed erosion refers to the ability of the sediment cover layer to buffer the impacts of water flow, reduce streambed erosion, and maintain streambed stability.

The per unit area refers to a particular unit of area, usually expressed in square meters (m²) or hectares (ha). The total deposition mass on the per unit area of the flash flood refers to a total weight of the sediment carried by the flash flood and deposited in the per unit area.

The original soil refers to natural soil that has not been eroded or damaged.

The detachment coefficient refers to a parameter used to quantify the impact of raindrop impact on soil erosion.

In some embodiments, in the calculating the degree of the protective capacity of the sediment cover layer against the bed erosion H, calculation equations for the deposition mass m_{f} of the fine particles of the flash flood on the per unit area and the deposition mass m_{c} of the coarse particles of the flash flood on the per unit area are, respectively:

$$\frac{1}{{ρ}_{s}} \frac{\partial {m}_{f}}{\partial t} = {D}_{f} - {r}_{rf} - {e}_{rf} \qquad ( 26 )$$

$$\frac{1}{{ρ}_{s}} \frac{\partial {m}_{c}}{\partial t} + \frac{\partial {q}_{b x}}{\partial x} + \frac{\partial {q}_{b y}}{\partial y} = {D}_{f} - {r}_{rc} - {e}_{rc} \qquad ( 27 )$$

wherein m_{f} denotes the deposition mass of the fine particles of the flash flood on the per unit area, united in kg/m²; m_{c} denotes the deposition mass of the coarse particles of the flash flood on the per unit area, united in kg/m²; ρₛ=2650 denotes an intrinsic density of the particles in the flash flood and debris flow, united in kg/m³; D_{f} denotes the deposition rate of the fine particles in the flash flood and debris flow, united in m/s;

$${r}_{rf} = \frac{{m}_{f}}{{m}_{f} + {m}_{c}} {r}_{r}$$

denotes a splash erosion rate of the fine particles for the deposition sediment by the rainfall, united in m/s;

$${e}_{rf} = ( 1 - {λ}_{p} ) \frac{{m}_{f}}{{m}_{f} + {m}_{c}} {e}_{r}$$

denotes an erosion rate of the fine particles for the deposition sediment by the flash flood, united in m/s; λₚ denotes the bed porosity, expressed in dimensionless units; D_{c} denotes the deposition rate of the coarse particles in the flash flood and debris flow, united in m/s;

$${r}_{rc} = \frac{{m}_{c}}{{m}_{f} + {m}_{c}} {r}_{r}$$

denotes a splash erosion of the coarse particles for the deposition sediment by flash flood, united in m/s;

$${e}_{rc} = ( 1 - {λ}_{p} ) \frac{{m}_{c}}{{m}_{f} + {m}_{c}} {e}_{r}$$

denotes an erosion rate of the coarse particles for the deposition sediment by the flash flood, united in m/s; eᵣ denotes an erosion rate for the deposition sediment by the flash flood, united in m/s; q_{bx} denotes the bed load transport rate per unit width along the x-direction, united in m²/s; q_{by} denotes the bed load transport rate per unit width along the y-direction, united in m²/s.

In some embodiments, in the calculating the degree of the protective capacity of the sediment cover layer against the bed erosion, the detachment coefficient a of the original soil under the raindrop impact and the detachment coefficient aᵣ of the sediment under the raindrop impact are calculated by:

$$a = \{ \begin{matrix}{a}_{0} if {h}^{′} < {h}_{rc} \\ {{a}_{0} ( {h}_{rc} / {h}^{′} )}^{b} if {h}^{′} \geq {h}_{rc}\end{matrix} \qquad ( 28 )$$

$${a}_{r} = \{ \begin{matrix}{a}_{r 0} if {h}^{′} < {h}_{rc} \\ {{a}_{r 0} ( {h}_{rc} / {h}^{′} )}^{b} if {h}^{′} \geq {h}_{rc}\end{matrix} \qquad ( 29 )$$

wherein a denotes the detachment coefficient of the original soil under the raindrop impact, expressed in dimensionless units; a₀ denotes the detachment coefficient of the original soil under the raindrop impact without influence of flash flood runoff, expressed in dimensionless units; aᵣ denotes the detachment coefficient of the sediment under the raindrop impact, expressed in dimensionless units; aᵣ₀ denotes the detachment coefficient of the sediment under the raindrop impact without the influence of flash flood runoff, expressed in dimensionless units; h_{rc}=dᵣ/3 denotes a critical flash flood depth at which the rainfall detaches sediment particles directly, united in m; dᵣ denotes an average diameter of rainfall droplets, united in m; h′=h/cos θ denotes a flash flood depth perpendicular to a trench direction, united in m; h denotes the flow depth of the flash flood and debris flow, united in m; θ denotes a slope angle, which is calculated from topography, united in °; b denotes an attenuation exponent for influence of the flow depth of the flash flood and debris flow on a detachment coefficient of the rainfall raindrops.

The bed porosity refers to a ratio of pore volume to total volume in the torrent bed. The pore volume refers to a portion of the void in the torrent bed that is not occupied by solid particles; the total volume refers to a total volume of the solid particles and pores in the torrent bed.

The deposition rate refers to a thickness or mass of sediment accumulating in a region (e.g., riverbed, lake bottom, seafloor, etc.) per unit of time. The deposition rate may also be referred to as a rate of deposition.

The bed load refers to sediment particles, such as sand and gravel, that move along the bottom of a river or gully by rolling, sliding, or bouncing.

The bed load transport rate per unit width refers to an amount of sand transported by the bed load per unit width of channel or gully per unit time.

The flash flood runoff refers to a sudden, high-intensity water flow formed in mountainous or hilly regions where surface runoff rapidly pools due to short periods of heavy rainfall or melting snow and ice.

The critical flash flood depth refers to a minimum depth of the water that water flows have a direct stripping effect on surface sediment particles during the flash flood or rainfall. When the water depth reaches or exceeds the critical value, the water flow has sufficient energy and shear to directly strip and transport sediment particles, thus triggering erosion.

The attenuation exponent for the influence of the flow depth of the flash flood and debris flow on the detachment coefficient of the rainfall raindrops refers to a parameter used to quantify the extent to which the influence of the depth of the flash flood on the stripping of rainfall raindrops is attenuated. The detachment coefficient of the rainfall raindrops refers to a quantitative parameter that measures the ability of raindrops to dislodge soil particles from the surface during rainfall.

In some embodiments,

$${r}_{rf} = \frac{{m}_{f}}{{m}_{f} + {m}_{c}} {r}_{r}$$

is the splash erosion rate of the fine particles for the deposition sediment by the flash flood, which is assumed herein to have an impact on only the torrent bed materials.

In some embodiments, in E=Γ(r_{w}+e_{w})+(1−Γ)e_{d}, the total erosion rate of the torrent bed materials by the flash flood e_{w} includes two parts of an erosion rate of the original soil sediment by the flash flood e₀ and an erosion rate of the deposition sediment by the flash flood eᵣ, i.e.

$${e}_{w} = {e}_{0} + {e}_{r} \qquad ( 30 )$$

$${e}_{0} = ( 1 - H ) max \{ {k}_{0} ( τ - {τ}_{c 0} ) , 0 \} \qquad ( 31 )$$

$${e}_{r} = H max \{ {k}_{f} ( τ - {τ}_{cf} ) , 0 \} \qquad ( 32 )$$

wherein e_{w} denotes the total erosion rate of the torrent bed materials by the flash flood, united in m/s; e₀ denotes the erosion rate of the original soil sediment matter by the flash flood, united in m/s; eᵣ denotes the erosion rate of the sediment deposition matter by the flash flood, united in m/s; H denotes the degree of the protective capacity of the sediment cover layer against the bed erosion, expressed in dimensionless units; τ=\sqrt{τ_{bx}²+τ_{by}²} denotes a combined resistance of a bottom-bed of the flash flood and debris flow, united in Pa; τ_{bx} denotes a bottom-bed resistance of the flash flood and debris flow along the x-direction, united in Pa; τ_{by} denotes a bottom-bed resistance of the flash flood and debris flow along the y-direction, united in Pa; τ_{c0} denotes a cohesion resistance of the torrent bed materials when the flash flood erodes the original soil, united in Pa; τ_{cf} denotes a cohesion resistance of the torrent bed materials when the flash flood erodes the deposition sediment, united in Pa; k₀ denotes an empirical coefficient when the flash flood erodes the original soil, united in m/(Pa·s); k_{f} denotes an empirical coefficient when the flash flood erodes the deposition sediment, united in m/(Pa·s).

In some embodiments, in the E=Γ(r_{w}+e_{w})+(1−Γ)e_{d}, the total erosion rate of the debris flow e_{d} includes two parts of an erosion rate of the original soil sediment by the debris flow e_{d0} and an erosion rate of the deposition sediment by the debris flow ear, an calculation equation is:

$${e}_{d} = {e}_{d 0} + {e}_{dr} \qquad ( 33 )$$

$${e}_{d 0} = ( 1 - H ) \frac{τ - [ ρ gh cos θ ( 1 - λ ) tan {φ}_{o} + {c}_{o} ]}{{ρ}^{\sqrt{{u}^{2} + {v}^{2}}}} \qquad ( 34 )$$

$${e}_{dr} = H \frac{τ - [ ρ gh cos θ ( 1 - λ ) tan {φ}_{r} + {c}_{r} ]}{ρ \sqrt{{u}^{2} + {v}^{2}}} \qquad ( 35 )$$

wherein e_{d} denotes the total erosion rate of the debris flow, united in m/s; e_{d0} denotes the erosion rate of the original soil sediment by the debris flow, united in m/s; ear denotes the erosion rate of the deposition sediment by the debris flow, united in m/s; H denotes the degree of the protective capacity of the sediment cover layer against the bed erosion, expressed in dimensionless units; τ=\sqrt{τ_{bx}²+τ_{by}} denotes the combined resistance of the bottom-bed of the flash flood and debris flow, united in Pa; τ_{bx} denotes the bottom-bed resistance of the flash flood and debris flow along the x-direction, united in Pa; τ_{by} denotes the bottom-bed resistance of the flash flood and debris flow along the y-direction, united in Pa; u denotes the velocity of the flash flood and debris flow along the x-direction, united in m/s; v denotes the velocity of the flash flood and debris flow along the y-direction, united in m/s; ρ denotes the density of the flash flood and debris flow, united in kg/m³; h denotes the flow depth of the flash flood and debris flow, united in m; λ denotes a pore water pressure coefficient in the torrent bed materials when the debris flow erodes the trench, expressed in dimensionless units; θ denotes the slope angle, which is calculated from the topography, united in °; φ₀ denotes a friction angle of original soil particles when the debris flow erodes the original soil in the trench, united in °; c₀ denotes a cohesive resistance of the original soil when the debris flow erodes the original soil in the trench, united in Pa; φᵣ denotes a friction angle of flood-deposited particles when the debris flow erodes the deposition sediment in the trench, united in °; cᵣ denotes a cohesive resistance of the deposition sediment when the debris flow erodes the deposition sediment in the trench, united in Pa; g=9.81 denotes the gravitational acceleration, united in m/s².

The combined resistance of the bottom-bed of the flash flood and debris flow refers to a sum of all the resistances exerted on the debris flow. by the bottom-bed during the flow of the debris flow.

The cohesion resistance refers to the ability of surface materials (e.g., soil, rock, etc.) to resist erosion by external forces (e.g., water flow, wind, gravity, etc.).

The empirical coefficient refers to a parameter derived from fitting experimental or observational data to quantify the intensity or rate of flash flood erosion.

max {A,B} means that the numbers A and B take the maximum value.

The pore water pressure coefficient refers to data that characterizes the relationship between pore water pressure and external stresses (e.g., debris flow shear) in the torrent bed materials.

The cohesive resistance refers to cohesive resistance between soil or sediment particles due to molecular forces, chemical bonding, or cementation. The total erosion rate of the torrent bed materials by the flash flood refers to a depth of erosion of the torrent bed materials by the flash flood per unit of time.

The total erosion rate of the debris flow refers to a depth to which the debris flow erodes the torrent bed materials per unit of time.

The transition factor from the flash flood to the debris flow refers to a key condition or influence that contributes to the transformation from the flash flood to the debris flow. For example, the transition factor includes the supply of loose material, hydrodynamic conditions, and topographic conditions.

The attenuation exponent refers to a mathematical parameter used to describe the rate at which the transition factor gradually weakens over time, space, etc.

The critical total concentration refers to a threshold for the concentration of the particles in a fluid. When the concentration of the particles is below the critical total concentration, the fluid behaves mainly as the flash flood; when the concentration is above the critical total concentration, the fluid behaves mainly as the debris flow.

The erosion rate refers to a rate at which the surface of the earth or a geologic body is eroded, denuded, or destroyed by natural or man-made action. The erosion rate may also be referred to as the rate of erosion.

The diffusion coefficient refers to mass of a substance that passes through the per unit area per unit time at a unit concentration gradient.

In some embodiments, in the transport equations, calculation formulas of the erosion rate of the water E_{w}, the erosion rate of the coarse particles E_{c}, and the erosion rate of the fine particles E_{f} during the movement of the flash flood and debris flow are calculated as follows, respectively:

$${E}_{w} = Γ ( {α}_{b w} {e}_{0} + {λ}_{p} {e}_{r} ) + ( 1 - Γ ) ( {α}_{b w} {e}_{d 0} + {λ}_{p} {e}_{dr} ) \qquad ( 36 )$$

$${E}_{c} = Γ ( {r}_{0} \frac{{a}_{b c}}{{a}_{b f} + {a}_{b c}} + \frac{{m}_{c}}{{m}_{f} + {m}_{c}} {r}_{r} + {e}_{0} {α}_{b c} + ( 1 - {λ}_{p} ) \frac{{m}_{c}}{{m}_{f} + {m}_{c}} {e}_{r} ) + ( 1 - Γ ) ( {e}_{d 0} {α}_{b c} + ( 1 - {λ}_{p} ) \frac{{m}_{c}}{{m}_{f} + {m}_{c}} {e}_{dr} ) \qquad ( 37 )$$

$${E}_{f} = Γ ( {r}_{0} \frac{{a}_{b f}}{{a}_{b f} + {a}_{b c}} + \frac{{m}_{f}}{{m}_{f} + {m}_{c}} {r}_{r} + {e}_{0} {α}_{b f} + ( 1 - {λ}_{p} ) \frac{{m}_{f}}{{m}_{f} + {m}_{c}} {e}_{r} ) + ( 1 - Γ ) ( {e}_{d 0} {α}_{b f} + ( 1 - {λ}_{p} ) \frac{{m}_{f}}{{m}_{f} + {m}_{c}} {e}_{dr} ) \qquad ( 38 )$$

wherein E_{w} denotes the erosion rate of the water during the movement of the flash flood and debris flow, united in m/s; E_{c} denotes the erosion rate of the coarse particles during the movement of the flash flood and debris flow, united in m/s; E_{f} denotes the erosion rate of the fine particles during the movement of the flash flood and debris flow, united in m/s; Γ denotes the transition factor from the flash flood to the debris flow, expressed in dimensionless units; m_{f} denotes the deposition mass of the fine particles of the flash flood on the per unit area, united in kg/m²; m_{c} denotes the deposition mass of the coarse particles of the flash flood on the per unit area, united in kg/m²; α_{bw} denotes volumetric fraction of the water in the original soil of the trench, expressed in dimensionless units; α_{bc} denotes volumetric fraction of the coarse particles in the original soil of the trench, expressed in dimensionless units; α_{bf} denotes volumetric fraction of the fine particles in the original soil of the trench, expressed in dimensionless units; r₀ denotes the original soil sediment splash erosion rate due to the rainfall, united in m/s; rᵣ denotes the splash erosion rate for the deposition sediment due to the rainfall, united in m/s; e₀ denotes the erosion rate of the original soil sediment by the flash flood, united in m/s; eᵣ denotes the erosion rate for the deposition sediment by the flash flood, united in m/s; e_{d0} denotes the erosion rate of the original soil sediment by the debris flow, united in m/s; e_{dr} denotes the erosion rate for the deposition sediment by the debris flow, united in m/s; λₚ denotes the bed porosity, expressed in dimensionless units.

In some embodiments, a calculation formula of the diffusion coefficient ε_{f} of the fine particles in the transport equations for the fine particles is:

$${ε}_{f} = \frac{κ {u}_{*} h}{6} \qquad ( 39 )$$

wherein ε_{f} denotes the diffusion coefficient of the fine particles in the flash flood and debris flow, united in m²/s; κ=0.4 denotes von Karmen constant, expressed in dimensionless units;

$${u}_{⋆} = \sqrt{\frac{τ}{ρ}}$$

denotes a bed friction velocity of the flash flood and debris flow, united in m/s; τ=\sqrt{τ_{bx}²+τ_{by}²} denotes the combined resistance of the bottom-bed of the flash flood and debris flow, united in Pa; τ_{bx} denotes the bottom-bed resistance of the flash flood and debris flow along the x-direction, united in Pa; τ_{by} denotes the bottom-bed resistance of the flash flood and debris flow along the y-direction, united in Pa; ρ denotes the density of the flash flood and debris flow, united in kg/m³; h denotes the flow depth of the flash flood and debris flow, united in m.

In some embodiments, in the transport equations for the fine particles and the coarse particles, calculation formulas of deposition rates of the fine particle sediment and the coarse particle sediment in the flash flood runoff are:

$${D}_{f} = Γ {w}_{s f} {{c}_{f} ( 1 - {c}_{f} - {c}_{c} )}^{m} \qquad ( 40 )$$

$${D}_{c} = Γ {w}_{s c} {{c}_{c} ( 1 - {c}_{f} - {c}_{c} )}^{m} \qquad ( 41 )$$

wherein D_{f} denotes the deposition rate of the fine particles in the flash flood and debris flow, united in m/s; D_{c} denotes the deposition rate of the coarse particles in the flash flood and debris flow, united in m/s; c_{c} denotes the volumetric concentration of the coarse particles in the flash flood and debris flow, expressed in dimensionless units; c_{f} denotes the volumetric concentration of the fine particles in the flash flood and debris flow, expressed in dimensionless units; m denotes an empirical parameter range from a value of 2.0 to 5.0, expressed in dimensionless units; Γ denotes the transition factor from the flash flood to the debris flow, expressed in dimensionless units.

w_{sf} denotes a settling rate of the fine particles in the flash flood and debris flow, unite in m/s, and a calculation formula is:

$${w}_{sf} = \sqrt{{( 13.95 \frac{v}{{d}_{f}} )}^{2} + 1.09 \frac{( {ρ}_{s} - {ρ}_{w} )}{{ρ}_{w}} {gd}_{f}} - 13. 95 \frac{v}{{d}_{f}} \qquad ( 42 )$$

wherein v=10⁻⁶ denotes kinematic viscosity of the water, united in m²/s.

w_{sc} denotes a settling rate of the coarse particles in the flash flood and debris flow united in m/s, and a calculation formula is:

$${w}_{s c} = \sqrt{{( 13.95 \frac{v}{{d}_{c}} )}^{2} + 1.09 \frac{( {ρ}_{s} - {ρ}_{w} )}{{ρ}_{w}} g {d}_{c}} - 13.95 \frac{v}{{d}_{c}} \qquad ( 43 )$$

wherein v=10⁻⁶ denotes kinematic viscosity of the water, united in m²/s; d_{f} denotes a representative particle size of the fine particles in the flash flood and debris flow, united in m; ρₛ=2650 denotes an intrinsic density of the fine particles in the flash flood and debris flow, united in kg/m³; ρ_{w}=1000 denotes a density of the clear water, united in kg/m³; g=9.81 denotes the gravitational acceleration, united in m/s².

The bed friction velocity of the flash flood and debris flow refers to data used to characterize the interaction of the debris flow with the bed during flow.

The representative particle size of the coarse particles refers to a characteristic value used to characterize the particle size distribution of the particles. For example, the representative particle size includes a median particle size, a mean particle size, a plurality of particle sizes, or the like.

Since sediment particles in the debris flow are thoroughly mixed during the movement, the flow exhibits strong integrity. The settling of the sediment particles is negligible, and only the settling of the fine particles and the coarse particles for the deposition sediment during the movement of the flash flood is considered.

The settling rate refers to a rate at which particles or objects sink in a fluid due to gravity.

In some embodiments, in the formulas

$$( 1 - {λ}_{p} ) \frac{\partial {z}_{b}}{\partial t} = \text{} - \frac{\partial {q}_{b x}}{\partial x} - \frac{\partial {q}_{b x}}{\partial y} + D - E and \frac{1}{{ρ}_{s}} \frac{\partial {m}_{c}}{\partial t} + \frac{\partial {q}_{b x}}{\partial x} + \frac{\partial {q}_{b y}}{\partial y} = {D}_{c} - {r}_{rc} - {e}_{rc} ,$$

the bed load transport rate per unit width along the x-direction q_{bx} and the bed load transport rate per unit width along the y-direction q_{by} are calculated as follows, respectively:

$${q}_{b x} = {q}_{b} \frac{p}{\sqrt{{p}^{2} + {q}^{2}}} \qquad ( 44 )$$

$${q}_{by} = {q}_{b} \frac{q}{\sqrt{{p}^{2} + {q}^{2}}} \qquad ( 45 )$$

wherein q_{bx} denotes the bed load transport rate per unit width along the x-direction, united in m²/s; q_{by} denotes the bed load transport rate per unit width along the y-direction, united in m²/s; ρ denotes the discharge per unit width of the flash flood and debris flow along the x-direction, united in m²/s; q denotes the discharge per unit width of the flash flood and debris flow along the y-direction, united in m²/s.

q_{b} denotes a sediment transport rate per unit width of the coarse particles, united in m²/s, and a calculation formula is:

$$\frac{{q}_{b}}{{d}_{c} \sqrt{\frac{( {ρ}_{s} - {ρ}_{w} )}{{p}_{w}} {gd}_{c}}} = 2.5 \sqrt{{τ}_{*}} max \{ ( {τ}_{*} - {τ}_{* c} ) , 0 \} Fr \qquad ( 46 )$$

$$wherein$$

$$Fr = \frac{\sqrt{{u}^{2} + {v}^{2}}}{\sqrt{g h}}$$

denotes Froude number for fluid expressed in dimensionless units; h denotes the flow depth of the flash flood and debris flow, united in m; u denotes the velocity of the flash flood and debris flow along the x-direction, united in m/s; v denotes the velocity of the flash flood and debris flow along the y-direction, united in m/s;

$${τ}_{*} = \frac{\sqrt{{τ}_{bx}^{2} + {τ}_{by}^{2}}}{( {ρ}_{s} - {ρ}_{w} ) {gd}_{c}}$$

denotes Shields number expressed in dimensionless units; ρ_{bx} denotes the bottom-bed resistance of the flash flood and debris flow along the x-direction, united in Pa; τ_{by} denotes the bottom-bed resistance of the flash flood and debris flow along the y-direction, united in Pa; ρₛ=2650 denotes the intrinsic density of the coarse particles in the flash flood and debris flow, united in kg/m³; ρ_{w}=1000 denotes the density of the clear water, united in kg/m³; d_{c} denotes the representative particle size of the coarse particles in the flash flood and debris flow, united in m; g=9.81 denotes the gravitational acceleration, united in m/s².

τ_{*c} denotes a critical Shields number, expressed in dimensionless units, and a calculation formula is:

$${τ}_{* c} = {τ}_{* c 0} \frac{sin ( {ϕ}_{b e d} - θ )}{sin ( {ϕ}_{b e d} )} [ 0.5 + 6 {( tan θ )}^{0.75} ] \qquad ( 47 )$$

wherein τ_{*c0}=0.045 denotes an empirical coefficient, expressed in dimensionless units; θ denotes the slope angle, which is calculated from the topography, united in °; φ_{bed} denotes a friction angle of particles when the debris flow erodes the trench, united in °.

In summary, by adopting the aforementioned technical approach, based on the theory of continuum mechanics, the present disclosure realizes the numerical simulation method for the flash flood and debris flow considering rainfall conditions by a difference approach based on the continuum medium mechanics manner coupled with the hydrodynamic model of the three-phase medium of the water, the coarse particles, and the fine particles. The method in the present disclosure is able to simulate the formation, movement, and sediment transport processes of the flash flood and debris flow under different rainfall conditions. The present disclosure establishes a quantitative analysis model to investigate how vegetation conditions, fine particles and coarse particles for the deposition sediment transport influence the formation and movement processes of the flash flood and debris flow triggered by runoff. The model enables real-time determination of whether the fluid formed under specific rainfall conditions is the flash flood or the debris flow, and the density of the flash flood and debris flow, based on rainfall processes, vegetation distribution, and soil gradation parameters. Based on the computational results, corresponding prevention measures and management strategies are formulated.

### Experimental Embodiment

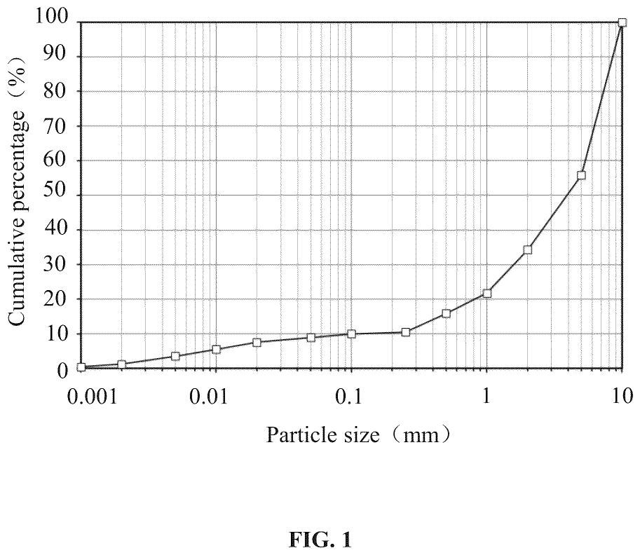

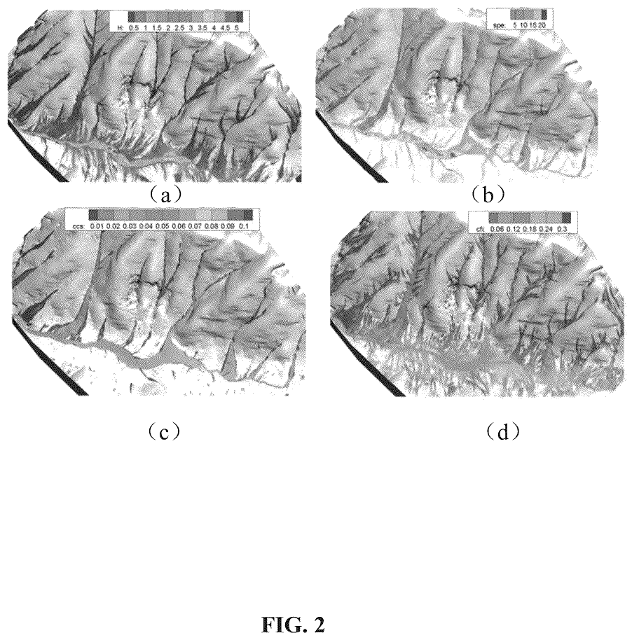

A simulation check is performed in a ditch in Sichuan as an example. The trench matter of the ditch in August 2023 was activated by heavy rainfall to form a debris flow. Through measurement and corresponding calculations, a vegetation coverage of the ditch is determined to be 0.55, a vegetation penetration coefficient is 0.35, an attenuation coefficient of a canopy drainage rate is 0.0039 m⁻¹, total canopy water storage capacity is 0.002 m, and a drainage coefficient when canopy water storage capacity reaches the total canopy water storage capacity is 5×10⁻⁵ mm/s. The peak rainfall intensity of the storm (i.e., the peak of rainfall intensity) is 60 mm/h, lasting for 1200 s. A steady infiltration rate of soil is 40 mm/h, and an initial infiltration rate of the soil is 3 mm/h. A constant describing an attenuation process of rainfall infiltration over time is 0.5 h⁻¹. A deposition mass required to protect original soil from further erosion on the per unit area is 3 kg/m². A detachment coefficient of the original soil under the raindrop impact without influence of flash flood runoff is 3.4, a detachment coefficient of sediment under the raindrop impact is 154.7, an attenuation exponent for influence of a flow depth of the flash flood and debris flow on a detachment coefficient of the rainfall raindrops is 1.13, and an average diameter of rainfall droplets is 0.003 m. A cohesion resistance of the torrent bed materials when the flash flood erodes the original soil is 50 Pa, and a cohesion resistance of the torrent bed materials when the flash flood erodes the deposition sediment is 10 Pa, an empirical coefficient when the flash flood erodes the original soil is 0.00059 m/(Pa·s), and an empirical coefficient when the flash flood erodes the deposition sediment is 0.00062 m/(Pa·s). A friction angle of original soil particles when the debris flow erodes the original soil in the trench is 35°, a cohesive resistance of the original soil particles when the debris flow erodes the original soil in the trench is 1000 Pa, a friction angle of flood-deposited particles when the debris flow erodes the deposition sediment in the trench is 28°, and a cohesive resistance of the deposition sediment when the debris flow erodes the deposition sediment in the trench is 300 Pa. A roughness coefficient of the rainfall-induced flash flood runoff in the trench is taken as 0.06 s/m^{1/3}. Volumetric fraction of the water in the original soil of the trench α_{bw} is 0.35 (expressed in dimensionless units), volumetric fraction of the coarse particles in the original soil of the trench α_{bc} is 0.38 (expressed in dimensionless units), volumetric fraction of the fine particles in the original soil of the trench α_{bf} is 0.27 (expressed in dimensionless units), and bed porosity λₚ is 0.35 (expressed in dimensionless units). An empirical parameter for particle settling during flash flood movement m is 3.0 (expressed in dimensionless units). An intrinsic density of the particles of the flash flood ρₛ=2650 kg/m³ and a density of the clear water ρ_{w}=1000 kg/m³. A friction angle between the coarse particles and the bottom-bed in the debris flow φₛ is 28°, a turbulence coefficient of the coarse particles in the flash flood and debris flow C_{Z} is 25.5 m^{1/2}/s. A representative particle size of the coarse particles in the flash flood and debris flow d_{c} is 0.008 m, and a representative particle size of the fine particles in the flash flood and debris flow d_{f} is 0.0005 m. A friction angle of particles when the debris flow eroded the trench φ_{bed} is 30°. FIG. 1 is a schematic diagram illustrating a particle size distribution curve of debris flow according to some embodiments of the present disclosure. FIG. 2 is a schematic diagram illustrating simulation results of the formation and movement of flash flood and debris flow in a ditch in Sichuan under rainfall conditions, according to some embodiments of the present disclosure. Based on a digital elevation model (DEM) of the debris flow ditch watershed range established from a 1:10,000 topographic map of the ditch, the above parameters were input into the numerical model to obtain the formation and movement process of the flash flood and debris flow under rainfall conditions, as shown in FIG. 2 Calculation results show that the maximum density of the flash flood and debris flow under the above parameterized conditions is 1759 kg/m³, and the transformation process from the flash flood to the debris flow under rainfall conditions is successfully realized.

In FIG. 2, (a) is flow depth distribution of the flash flood and debris flow at 15 min; (b) is a velocity distribution of the flash flood and debris flow at 15 min; (c) is a distribution of volumetric concentration of coarse particles in the flash flood and debris flow at 15 min; and (d) is a distribution of volumetric concentration of the fine particles in the flash flood and debris flow at 15 min. FIG. 2 illustrates the movement characteristics and material composition of the flash flood and debris flow at the 15 min mark through the distribution of the flow depth, the velocity, the volumetric concentration of the coarse particles, and the volumetric concentration of the fine particles. This provides valuable reference for studying the dynamic properties of the debris flow, disaster assessment, and the design of mitigation measures.

The foregoing is only a preferred embodiment of the present disclosure, and is not intended to limit the present disclosure, and any modifications, equivalent replacements, improvements, etc. made within the spirit and principles of the present disclosure shall be included in the scope of protection of the present disclosure.

Some features, structures, or characteristics of one or more embodiments of the present disclosure may be suitably combined.

Numbers describing the number of components, attributes, and properties are used in some embodiments, and it is to be understood that such numbers used in the description of embodiments are modified in some examples by the modifiers “about,” “approximately,” or “substantially.” Unless otherwise noted, the terms “about,” “approximately,” or “substantially” indicate that a ±20% variation in the stated number is allowed. Correspondingly, in some embodiments, the numerical parameters used in the specification and claims are approximations, which may change depending on the desired characteristics of individual embodiments. While the numerical domains and parameters used in some embodiments of the present disclosure to confirm the breadth of their ranges are approximations, in specific embodiments such values are set as precisely as possible within a feasible range.

In the event of any inconsistency or conflict between the descriptions, definitions, and/or use of terms in the materials cited in the present disclosure and those described in the present disclosure, the descriptions, definitions, and/or use of terms in the present disclosure shall prevail.

1. A numerical simulation method for rainfall-induced flash flood and debris flow, comprising:
obtaining, based on a continuum medium mechanics manner coupled with a hydrodynamic model of a three-phase medium of water, coarse particles, and fine particles, data required for the numerical simulation method, the data including at least one of topographical data, temporal data of rainfall, vegetation distribution data, a volume content of initial coarse particles of a torrent bed, and a volume content of fine particles of the torrent bed;
wherein governing equations of the hydrodynamic model are:
$$\frac{\partial ( h )}{\partial t} + \frac{\partial ( h u )}{\partial x} + \frac{\partial ( h v )}{\partial y} = {R}_{e} - I + E - D$$
$$\frac{\partial p}{\partial t} + \frac{\partial }{\partial x} ( \frac{{p}^{2}}{h} ) + \frac{\partial }{\partial y} ( \frac{p q}{h} ) = - gh \frac{\partial ( h + {z}_{b} )}{\partial x} - \frac{{τ}_{bx}}{ρ} - ( {R}_{e} - I + E - D ) \frac{p}{h}$$
$$\frac{\partial q}{\partial t} + \frac{\partial }{\partial x} ( \frac{p q}{h} ) + \frac{\partial }{\partial y} ( \frac{{q}^{2}}{h} ) = - gh \frac{\partial ( h + {z}_{b} )}{\partial y} - \frac{{τ}_{by}}{ρ} - ( {R}_{e} - I + E - D ) \frac{q}{h}$$
wherein h denotes a flow depth of the flash flood and debris flow, united in m;
p=hu denotes a discharge per unit width of the flash flood and debris flow along an x-direction, united in m²/s;
q=hv denotes a discharge per unit width of the flash flood and debris flow along a y-direction, united in m²/s;
u denotes a velocity of the flash flood and debris flow along the x-direction, united in m/s;
v denotes a velocity of the flash flood and debris flow along the y-direction, united in m/s;
ρ=c_{w}ρ_{w}+(c_{f}+c_{c})ρₛ denotes a density of the flash flood and debris flow, united in kg/m³;
c_{w} denotes a volumetric concentration of water in the flash flood and debris flow, expressed in dimensionless units;
c_{c} denotes volumetric concentration of coarse particles in the flash flood and debris flow, expressed in dimensionless units;
c_{f} denotes volumetric concentration of fine particles in the flash flood and debris flow, expressed in dimensionless units;
ρₛ=2650 denotes an intrinsic density of particles in the flash flood and debris flow, united in kg/m³;
ρ_{w}=1000 denotes a density of the clear water, united in kg/m³;
τ_{bx} denotes a bottom-bed resistance of the flash flood and debris flow along the x-direction, united in Pa;
τ_{by} denotes a bottom-bed resistance of the flash flood and debris flow along the y-direction, united in Pa;
z_{b} denotes an elevation of terrain required for the numerical simulation method, united in m;
g=9.81 denotes a gravitational acceleration, united in m/s²;
Rₑ denotes an effective rainfall intensity, united in m/s;
I denotes a soil infiltration rate, united in m/s;
E=E_{w}+E_{f}+E_{c} denotes a total erosion rate of the flash flood and debris flow, united in m/s;
E_{w} denotes an erosion rate of the water during the movement of the flash flood and debris flow, united in m/s;
E_{c} denotes an erosion rate of coarse particles during the movement of the flash flood and debris flow, united in m/s;
E_{f} denotes an erosion rate of fine particles during the movement of the flash flood and debris flow, united in m/s;
D=D_{f}+D_{c} denotes total deposition rate of the particles in the flash flood and debris flow, united in m/s;
D_{f} denotes a deposition rate of fine particles in the flash flood and debris flow, united in m/s;
D_{c} denotes a deposition rate of coarse particles in the flash flood and debris flow, united in m/s;
t denotes time, united in s;
transport equations for the water, the fine particles, and the coarse particles in the flash flood and debris flow are as follows:
$$\frac{\partial ( h {c}_{w} )}{\partial t} + \frac{\partial ( {c}_{w} h u )}{\partial x} + \frac{\partial {c}_{w} h v}{\partial y} = {R}_{e} - I + {E}_{w}$$
$$\frac{\partial {hc}_{f}}{\partial t} + \frac{\partial ( h u {c}_{f} )}{\partial x} + \frac{\partial ( h v {c}_{f} )}{\partial y} = \frac{\partial }{\partial x} ( h {ε}_{f} \frac{\partial {c}_{f}}{\partial x} ) + \frac{\partial }{\partial y} ( h {ε}_{f} \frac{\partial {c}_{f}}{\partial y} ) + {E}_{f} - {D}_{f}$$
$$\frac{\partial ( h {c}_{c} )}{\partial t} + \frac{\partial ( h u {c}_{c} )}{\partial x} + \frac{\partial ( h v {c}_{c} )}{\partial y} = {E}_{c} - {D}_{c}$$
wherein h denotes the flow depth of the flash flood and debris flow, united in m;
u denotes the velocity of the flash flood and debris flow along the x-direction, united in m/s;
v denotes the velocity of the flash flood and debris flow along the y-direction, united in m/s;
c_{w} denotes the volumetric concentration of the water in the flash flood and debris flow, expressed in dimensionless units;
c_{c} denotes the volumetric concentration of the coarse particles in the flash flood and debris flow, expressed in dimensionless units;
c_{f} denotes the volumetric concentration of the fine particles in the flash flood and debris flow, expressed in dimensionless units;
Rₑ denotes the effective rainfall intensity, united in m/s;
I denotes the soil infiltration rate, united in m/s;
E_{w} denotes the erosion rate of the water during the movement of the flash flood and debris flow, united in m/s;
E_{c} denotes the erosion rate of the coarse particles during the movement of the flash flood and debris flow, united in m/s;
E_{f} denotes the erosion rate of the fine particles during the movement of the flash flood and debris flow, united in m/s;
D_{f} denotes the deposition rate of the fine particles in the flash flood and debris flow, united in m/s;
D_{c} denotes the deposition rate of the coarse particles in the flash flood and debris flow, united in m/s;
ε_{f} denotes a diffusion coefficient of the fine particles in the flash flood and debris flow, united in m²/s;
t denotes the time united in s; and/or
an evolutionary equation for the terrain is:
$$( 1 - {λ}_{p} ) \frac{\partial {z}_{b}}{\partial t} = - \frac{\partial {q}_{b x}}{\partial x} - \frac{\partial {q}_{by}}{\partial y} + D - E$$
wherein, λₚ denotes bed porosity, expressed in dimensionless units;
z_{b} denotes the elevation of the terrain, united in m;
E=E_{w}+E_{f}+E_{c} denotes the total erosion rate of the flash flood and debris flow, united in m/s;
E_{w} denotes the erosion rate of the water during the movement of the flash flood and debris flow, united in m/s;
E_{c} denotes the erosion rate of the coarse particles during the movement of the flash flood and debris flow united in m/s;
E_{f} denotes the erosion rate of the fine particles during the movement of the flash flood and debris flow, united in m/s;
D=D_{f}+D_{c} denotes the total deposition rate of the particles in the flash flood and debris flow, united in m/s;
D_{f} denotes the deposition rate of the fine particles in the flash flood and debris flow, united in m/s;
D_{c} denotes the deposition rate of the coarse particles in the flash flood and debris flow, united in m/s;
q_{bx} denotes bed load transport rate per unit width along the x-direction, united in m²/s;
q_{by} denotes bed load transport rate per unit width along the y-direction, united in m²/s;
t denotes the time, united in s.

2. (canceled)

3. The numerical simulation method for rainfall-induced the flash flood and debris flow of claim 1, wherein in the governing equations, a calculation formula for the effective rainfall intensity Rₑ is:
$${R}_{e} = R ( 1 - {C}_{v} ) + R {T}_{c} {C}_{v} + {W}_{c}$$
wherein Rₑ denotes the effective rainfall intensity, united in m/s;
R denotes an actual rainfall intensity, united in m/s;
Cᵥ denotes a vegetation coverage, expressed in dimensionless units;
T_{c} denotes a vegetation penetration coefficient, expressed in dimensionless units;
W_{c} denotes a canopy drainage rate, united in m/s;
a calculation formula of the canopy drainage rate W_{c} is:
$${W}_{c} = {K}_{c} {e}^{{g}_{c} ( C - S )}$$
wherein W_{c} denotes the canopy drainage rate, united in m/s;
g_{c} denotes an attenuation coefficient of the canopy drainage rate, united in m⁻¹;
S denotes total canopy water storage capacity, united in m;
C denotes canopy water storage capacity at a moment t, united in m;
K_{c} denotes a drainage coefficient when the canopy water storage capacity reaches the total canopy water storage capacity, united in m/s;
at the moment t, a calculation equation for the canopy water storage capacity C is:
$$\frac{d C}{d t} = ( 1 - {T}_{c} ) R {C}_{v} - {W}_{c}$$
wherein C denotes the canopy water storage capacity at the moment t, united in m;
T_{c} denotes the vegetation penetration coefficient, expressed in dimensionless units;
R denotes the actual rainfall intensity, united in m/s;
Cᵥ denotes the vegetation coverage, expressed in dimensionless units;
W_{c} denotes the canopy drainage rate, united in m/s;
t denotes the time united in s; and/or
a calculation formula of the soil infiltration rate I in the governing equations is:
$$I = {I}_{c} + ( {I}_{0} - {I}_{c} ) exp ( - kt )$$
wherein I denotes the soil infiltration rate, united in m/s;
I_{c} denotes a steady infiltration rate of the soil, united in m/s;
I₀ denotes an initial infiltration rate of the soil, united in m/s;
k denotes a constant describing an attenuation process of rainfall infiltration over time, united in s⁻¹;
t denotes the time, in s; and/or
in the governing equations, the total erosion rate E of the flash flood and debris flow is calculated as follows:
$$E = Γ ( {r}_{w} + {e}_{w} ) + ( 1 - Γ ) {e}_{d}$$
wherein E denotes the total erosion rate of the flash flood and debris flow, united in m/s;
r_{w} denotes a total sediment splash erosion rate of torrent bed materials due to the rainfall, united in m/s;
e_{w} denotes a total erosion rate of torrent bed materials by the flash flood, united in m/s;
e_{d} denotes a total erosion rate of the debris flow, united in m/s;
Γ denotes a transition factor from the flash flood to the debris flow, expressed in dimensionless units;
wherein a calculation formula of Γ is:
$$Γ = exp [ - α ( {c}_{f} + {c}_{c} ) / {c}_{g c} ]$$
wherein α denotes attenuation exponent, expressed in dimensionless units, with a value of 13.8;
c_{c} denotes the volumetric concentration of the coarse particles in the flash flood and debris flow, expressed in dimensionless units;
c_{f} denotes the volumetric concentration of the fine particles in the flash flood and debris flow, expressed in dimensionless units; c_{gc} denotes a critical total concentration at a boundary between the flash flood and the debris flow, expressed in dimensionless units, with a value of 0.18.

4. The numerical simulation method for rainfall-induced the flash flood and debris flow of claim 3, wherein
in the E=Γ(r_{w}+e_{w})+(1−Γ)e_{d}, the total sediment splash erosion rate of the torrent bed materials due to the rainfall r_{w} includes two parts of an original soil sediment splash erosion rate r₀ and a splash erosion rate of deposition sediment rᵣ, i.e.
$${r}_{w} = {r}_{0} + {r}_{r}$$
$${r}_{0} = ( 1 - H ) {aR}_{e}$$
$${r}_{r} = {Ha}_{r} {R}_{e}$$
wherein r_{w} denotes the total sediment splash erosion rate of the torrent bed materials due to the rainfall, united in m/s;
r₀ denotes the original soil sediment splash erosion rate due to the rainfall, united in m/s;
rᵣ denotes the splash erosion rate of the deposition sediment due to the rainfall, united in m/s;
Rₑ denotes the effective rainfall intensity, united in m/s;
H=min (m_{τ}/m_{τ}*, 1), which is a degree of a protective capacity of a sediment cover layer against a bed erosion, expressed in dimensionless units;
m_{τ}=m_{f}+m_{c}, which is a total deposition mass on per unit area of the flash flood, united in kg/m²;
m_{f} denotes a deposition mass of the fine particles of the flash flood on the per unit area, united in kg/m²;
m_{c} denotes a deposition mass of the coarse particles of the flash flood on the per unit area, united in kg/m²;
m_{τ}* denotes a deposition mass required to protect original soil from further erosion on the per unit area, united in kg/m²;
a denotes a detachment coefficient of the original soil under raindrop impact, expressed in dimensionless units;
aᵣ denotes a detachment coefficient of the sediment under the raindrop impact, expressed in dimensionless units.

5. The numerical simulation method for rainfall-induced the flash flood and debris flow of claim 4, comprising
calculating the degree of the protective capacity of the sediment cover layer against the bed erosion H, wherein calculation equations for the deposition mass of the fine particles of the flash flood on the per unit area m_{f} and the deposition mass of the coarse particles of the flash flood on the per unit area m_{c} are:
$$\frac{1}{{ρ}_{s}} \frac{\partial {m}_{f}}{\partial t} = {D}_{f} - {r}_{rf} - {e}_{rf}$$
$$\frac{1}{{ρ}_{s}} \frac{\partial {m}_{c}}{\partial t} + \frac{\partial {q}_{b x}}{\partial x} + \frac{\partial {q}_{b y}}{\partial y} = {D}_{f} - {r}_{r c} - {e}_{r c}$$
wherein m_{f} denotes the deposition mass of the fine particles of the flash flood on the per unit area, united in kg/m²;
m_{c} denotes the deposition mass of the coarse particles of the flash flood on the per unit area, united in kg/m²;
ρₛ=2650 denotes an intrinsic density of the particles in the flash flood and debris flow, united in kg/m³;
D_{f} denotes the deposition rate of the fine particles in the flash flood and debris flow, united in m/s;
$${r}_{rf} = \frac{{m}_{f}}{{m}_{f} + {m}_{c}} {r}_{r}$$
denotes a splash erosion rate of the fine particles for the deposition sediment by flash flood, united in m/s;
$${e}_{rf} = ( 1 - {λ}_{p} ) \frac{{m}_{f}}{{m}_{f} + {m}_{c}} {e}_{r}$$
denotes an erosion rate of the fine particles for the deposition sediment by the flash flood, united in m/s;
λₚ denotes the bed porosity, expressed in dimensionless units;
D_{c} denotes the deposition rate of the coarse particles in the flash flood and debris flow, united in m/s;
$${r}_{rc} = \frac{{m}_{c}}{{m}_{f} + {m}_{c}} {r}_{r}$$
denotes a splash erosion of the coarse particles for the deposition sediment by flash flood, united in m/s;
$${e}_{r c} = ( 1 - {λ}_{p} ) \frac{{m}_{c}}{{m}_{f} + {m}_{c}} {e}_{r}$$
denotes an erosion rate of the coarse particles for the deposition sediment by the flash flood, united in m/s;
eᵣ denotes an erosion rate for the deposition sediment by the flash flood, united in m/s;
q_{bx} denotes the bed load transport rate per unit width along the x-direction, united in m²/s;
q_{by} denotes the bed load transport rate per unit width along the y-direction, united in m²/s; and/or
calculating the degree of the protective capacity of the sediment cover layer against the bed erosion H, wherein the detachment coefficient a of the original soil under the raindrop impact and the detachment coefficient aᵣ of the sediment under the raindrop impact are calculated by:
$$a = \{ \begin{matrix}{a}_{0} & if {h}^{′} < {h}_{r c} \\ {a}_{0} {( {h}_{r c} / {h}^{′} )}^{b} & if {h}^{′} \geq {h}_{r c}\end{matrix}$$
$${a}_{r} = \{ \begin{matrix}{a}_{r 0} & if {h}^{′} < {h}_{r c} \\ {a}_{r 0} {( {h}_{r c} / {h}^{′} )}^{b} & if {h}^{′} \geq {h}_{r c}\end{matrix}$$
wherein a denotes the detachment coefficient of the original soil under the raindrop impact, expressed in dimensionless units;
a₀ denotes the detachment coefficient of the original soil under the raindrop impact without influence of flash flood runoff, expressed in dimensionless units;
aᵣ denotes the detachment coefficient of the sediment under the raindrop impact, expressed in dimensionless units;
aᵣ₀ denotes the detachment coefficient of the sediment under the raindrop impact without the influence of flash flood runoff, expressed in dimensionless units;
h_{rc}=dᵣ/3 denotes a critical flash flood depth at which the rainfall detaches sediment particles directly, united in m;
dᵣ denotes an average diameter of rainfall droplets, united in m;
h′=h/cos θ denotes a flash flood depth perpendicular to a trench direction, united in m;
h denotes the flow depth of the flash flood and debris flow, united in m;
θ denotes a slope angle, which is calculated from topography, united in °;
b denotes an attenuation exponent for influence of the flow depth of the flash flood and debris flow on a detachment coefficient of the rainfall raindrops.

6. The numerical simulation method for rainfall-induced the flash flood and debris flow of claim 5, wherein in the E=Γ(r_{w}+e_{w})+(1−Γ)e_{d}, the total erosion rate of the torrent bed materials by the flash flood e_{w} includes two parts of an erosion rate of the original soil sediment by the flash flood e₀ and an erosion rate of the deposition sediment by the flash flood eᵣ, i.e.
$${e}_{w} = {e}_{0} + {e}_{r}$$
$${e}_{0} = ( 1 - H ) max \{ {k}_{0} ( τ - {τ}_{c 0} ) , 0 \}$$
$${e}_{r} = H max \{ {k}_{f} ( τ - {τ}_{c f} ) , 0 \}$$
wherein e_{w} denotes the total erosion rate of the torrent bed materials by the flash flood, united in m/s;
e₀ denotes the erosion rate of the original soil sediment matter by the flash flood, united in m/s;
eᵣ denotes the erosion rate of the sediment deposition matter by the flash flood, united in m/s;
H denotes the degree of the protective capacity of the sediment cover layer against the bed erosion, expressed in dimensionless units;
τ=\sqrt{τ_{bx}²+τ_{by}²} denotes a combined resistance of a bottom-bed of the flash flood and debris flow, united in Pa;
τ_{bx} denotes a bottom-bed resistance of the flash flood and debris flow along the x-direction, united in Pa;
τ_{by} denotes a bottom-bed resistance of the flash flood and debris flow along the y-direction, united in Pa;
τ_{c0} denotes a cohesion resistance of the torrent bed materials when the flash flood erodes the original soil, united in Pa;
τ_{cf} denotes a cohesion resistance of the torrent bed materials when the flash flood erodes the deposition sediment, united in Pa;
k₀ denotes an empirical coefficient when the flash flood erodes the original soil, united in m/(Pa·s)
k_{f} denotes an empirical coefficient when the flash flood erodes the deposition sediment, united in m/(Pa·s); and/or
in the E=Γ(r_{w}+e_{w})+(1−Γ)e_{d}, the total erosion rate of the debris flow e_{d} includes two parts of an erosion rate of the original soil sediment by the debris flow e_{d0} and an erosion rate of the deposition sediment by the debris flow e_{dr}, a calculation equation is:
$${e}_{d} = {e}_{d 0} + {e}_{d r}$$
$${e}_{d 0} = ( 1 - H ) \frac{τ - [ pgh cos θ ( 1 - λ ) tan {φ}_{0} + {c}_{0} ]}{ρ \sqrt{{u}^{2} + {v}^{2}}}$$
$${e}_{d r} = H \frac{τ - [ pgh cos θ ( 1 - λ ) tan {φ}_{r} + {c}_{r} ]}{ρ \sqrt{{u}^{2} + {v}^{2}}}$$
wherein e_{d} denotes the total erosion rate of the debris flow, united in m/s;
e_{d0} denotes the erosion rate of the original soil sediment by the debris flow, united in m/s;
e_{dr} denotes the erosion rate of the deposition sediment by the debris flow, united in m/s;
H denotes the degree of the protective capacity of the sediment cover layer against the bed erosion, expressed in dimensionless units;
τ=\sqrt{τ_{bx}²+τ_{by}²} denotes the combined resistance of the bottom-bed of the flash flood and debris flow, united in Pa;
τ_{bx} denotes the bottom-bed resistance of the flash flood and debris flow along the x-direction, united in Pa;
τ_{by} denotes the bottom-bed resistance of the flash flood and debris flow along the y-direction, united in Pa;
u denotes the velocity of the flash flood and debris flow along the x-direction, united in m/s;
v denotes the velocity of the flash flood and debris flow along the y-direction, united in m/s;
ρ denotes the density of the flash flood and debris flow, united in kg/m³;
h denotes the flow depth of the flash flood and debris flow, united in m;
λ denotes a pore water pressure coefficient in the torrent bed materials when the debris flow erodes the trench, expressed in dimensionless units;
θ denotes the slope angle, which is calculated from the topography, united in °;
φ₀ denotes a friction angle of original soil particles when the debris flow erodes the original soil in the trench, united in °;
c₀ denotes a cohesive resistance of the original soil when the debris flow erodes the original soil in the trench, united in Pa;
φᵣ denotes a friction angle of flood-deposited particles when the debris flow erodes the deposition sediment in the trench, united in °;
cᵣ denotes a cohesive resistance of the deposition sediment when the debris flow erodes the deposition sediment in the trench, united in Pa;
g=9.81 denotes the gravitational acceleration, united in m/s².

7. The numerical simulation method for rainfall-induced the flash flood and debris flow of claim 6, wherein in the transport equations, calculation formulas of the erosion rate of the water E_{w}, the erosion rate of the coarse particles E_{c}, and the erosion rate of the fine particles E_{f} during the movement of the flash flood and debris flow are calculated as follows, respectively:
$${E}_{w} = Γ ( {α}_{b w} {e}_{0} + {λ}_{p} {e}_{r} ) + ( 1 - Γ ) ( {α}_{b w} {e}_{d 0} + {λ}_{p} {e}_{d r} )$$
$${E}_{c} = Γ ( {r}_{0} \frac{{α}_{b c}}{{α}_{b f} + {α}_{b c}} + \frac{{m}_{c}}{{m}_{f} + {m}_{c}} {r}_{r} + {e}_{0} {α}_{b c} + ( 1 - {λ}_{p} ) \frac{{m}_{c}}{{m}_{f} + {m}_{c}} {e}_{r} ) + ( 1 - Γ ) ( {e}_{d 0} {α}_{b c} + ( 1 - {λ}_{p} ) \frac{{m}_{c}}{{m}_{f} + {m}_{c}} {e}_{d r} )$$
$${E}_{f} = Γ ( {r}_{0} \frac{{α}_{b f}}{{α}_{b f} + {α}_{b c}} + \frac{{m}_{f}}{{m}_{f} + {m}_{c}} {r}_{r} + {e}_{0} {α}_{b f} + ( 1 - {λ}_{p} ) \frac{{m}_{f}}{{m}_{f} + {m}_{c}} {e}_{r} ) + ( 1 - Γ ) ( {e}_{d 0} {α}_{b f} + ( 1 - {λ}_{p} ) \frac{{m}_{f}}{{m}_{f} + {m}_{c}} {e}_{d r} )$$
wherein E_{w} denotes the erosion rate of the water during the movement of the flash flood and debris flow, united in m/s;
E_{c} denotes the erosion rate of the coarse particles during the movement of the flash flood and debris flow, united in m/s;
E_{f} denotes the erosion rate of the fine particles during the movement of the flash flood and debris flow, united in m/s;
Γ denotes the transition factor from the flash flood to the debris flow, expressed in dimensionless units;
m_{f} denotes the deposition mass of the fine particles of the flash flood on the per unit area, united in kg/m²;
m_{c} denotes the deposition mass of the coarse particles of the flash flood on the per unit area, united in kg/m²;
α_{bw} denotes volumetric fraction of the water in the original soil of the trench, expressed in dimensionless units;
α_{bc} denotes volumetric fraction of the coarse particles in the original soil of the trench, expressed in dimensionless units;
α_{bf} denotes volumetric fraction of the fine particles in the original soil of the trench, expressed in dimensionless units;
r₀ denotes the original soil sediment splash erosion rate due to the rainfall, united in m/s;
rᵣ denotes the splash erosion rate for the deposition sediment due to the rainfall, united in m/s;
e₀ denotes the erosion rate of the original soil sediment by the flash flood, united in m/s;
eᵣ denotes the erosion rate for the deposition sediment by the flash flood, united in m/s;
e_{d0} denotes the erosion rate of the original soil sediment by the debris flow, united in m/s;
e_{dr} denotes the erosion rate for the deposition sediment by the debris flow, united in m/s;
λₚ denotes the bed porosity, expressed in dimensionless units; and/or
a calculation formula of the diffusion coefficient E_{f} of the fine particles in the transport equations for the fine particles is:
$${ε}_{f} = \frac{κ {u}_{*} h}{6}$$
wherein ε_{f} denotes the diffusion coefficient of the fine particles in the flash flood and debris flow, united in m²/s;
κ=0.4 denotes von Karmen constant, expressed in dimensionless units;
$${u}_{*} = \sqrt{\frac{τ}{ρ}}$$
denotes a bed friction velocity of the flash flood and debris flow, united in m/s;
τ=\sqrt{τ_{bx}²+τ_{by}²} denotes the combined resistance of the bottom-bed of the flash flood and debris flow, united in Pa;
ρ_{bx} denotes the bottom-bed resistance of the flash flood and debris flow along the x-direction, united in Pa;
τ_{by} denotes the bottom-bed resistance of the flash flood and debris flow along the y-direction, united in Pa;
ρ denotes the density of the flash flood and debris flow, united in kg/m³;
h denotes the flow depth of the flash flood and debris flow, united in m; and/or
in the transport equations for the fine particles and the coarse particles, calculation formulas of deposition rates of the fine particle sediment and the coarse particle sediment in flash flood runoff are:
$${D}_{f} = Γ {w}_{s f} {{c}_{f} ( 1 - {c}_{f} - {c}_{c} )}^{m}$$
$${D}_{c} = Γ {w}_{s c} {{c}_{c} ( 1 - {c}_{f} - {c}_{c} )}^{m}$$
wherein D_{f} denotes the deposition rate of the fine particles in the flash flood and debris flow, united in m/s;
D_{c} denotes the deposition rate of the coarse particles in the flash flood and debris flow, united in m/s;
c_{c} denotes the volumetric concentration of the coarse particles in the flash flood and debris flow, expressed in dimensionless units;
c_{f} denotes the volumetric concentration of the fine particles in the flash flood and debris flow, expressed in dimensionless units;
m denotes an empirical parameter range from a value of 2.0 to 5.0, expressed in dimensionless units;
Γ denotes the transition factor from the flash flood to the debris flow, expressed in dimensionless units;
w_{sf} denotes a settling rate of the fine particles in the flash flood and debris flow united in m/s, a calculation formula is:
$${w}_{sf} = \sqrt{{( 13.95 \frac{v}{{d}_{f}} )}^{2} + 1.09 \frac{( {ρ}_{s} - {ρ}_{w} )}{{ρ}_{w}} {gd}_{f}} - 13.95 \frac{v}{{d}_{f}}$$
wherein v=10-6 denotes kinematic viscosity of the water, united in m²/s;
d_{f} denotes a representative particle size of the fine particles in the flash flood and debris flow, united in m;
ρₛ=2650 denotes an intrinsic density of the fine particles in the flash flood and debris flow, united in kg/m³;
ρ_{w}=1000 denotes a density of clear water, united in kg/m³;
g=9.81 denotes the gravitational acceleration, united in m/s²;
w_{sc} denotes a settling rate of the coarse particles in the flash flood and debris flow united in m/s, a calculation formula is:
$${w}_{sc} = \sqrt{{( 13.95 \frac{v}{{d}_{c}} )}^{2} + 1.09 \frac{( {ρ}_{s} - {ρ}_{w} )}{{ρ}_{w}} {gd}_{c}} - 13.95 \frac{v}{{d}_{c}}$$
wherein v=10-6 denotes the kinematic viscosity of the water, united in m²/s;
d_{c} denotes a representative particle size of the coarse particles in the flash flood and debris flow, united in m;
ρₛ=2650 denotes an intrinsic density of the coarse particles in the flash flood and debris flow, united in kg/m³;
ρ_{w}=1000 denotes the density of the clear water, united in kg/m³;
g=9.81 denotes the gravitational acceleration, united in m/s².

8. The numerical simulation method for rainfall-induced the flash flood and debris flow of claim 5, wherein in the formulas
$$( 1 - {λ}_{p} ) \frac{\partial {z}_{b}}{\partial t} = - \frac{\partial {q}_{bx}}{\partial x} - \frac{\partial {q}_{bx}}{\partial y} + D - E and \frac{1}{{ρ}_{s}} \frac{\partial {m}_{c}}{\partial t} + \frac{\partial {q}_{bx}}{\partial x} + \frac{\partial {q}_{by}}{\partial y} = {D}_{c} - {r}_{rc} - {e}_{rc} ,$$
the bed load transport rate per unit width along the x-direction q_{bx} and the bed load transport rate per unit width along the y-direction q_{by} are calculated, respectively:
$${q}_{bx} = {q}_{b} \frac{p}{\sqrt{{p}^{2} + {q}^{2}}}$$
$${q}_{by} = {q}_{b} \frac{q}{\sqrt{{p}^{2} + {q}^{2}}}$$
wherein q_{bx} denotes the bed load transport rate per unit width along the x-direction, united in m²/s;
q_{by} denotes the bed load transport rate per unit width along the y-direction, united in m²/s;
p denotes the discharge per unit width of the flash flood and debris flow along the x-direction, united in m²/s;
q denotes the discharge per unit width of the flash flood and debris flow along the y-direction, united in m²/s;
q_{b} denotes a sediment transport rate per unit width of the coarse particles, united in m²/s, a calculation formula is:
$$\frac{{q}_{b}}{\sqrt[{d}_{c}]{\frac{( {ρ}_{s} - {ρ}_{w} )}{{ρ}_{w}} {gd}_{c}}} = 2.5 \sqrt{{τ}_{*}} max \{ ( {τ}_{*} - {τ}_{* c} ) , 0 \} Fr wherein Fr = \frac{\sqrt{{u}^{2} + {v}^{2}}}{\sqrt{gh}}$$
denotes Froude number for fluid expressed in dimensionless units;
h denotes the flow depth of the flash flood and debris flow, united in m;
u denotes the velocity of the flash flood and debris flow along the x-direction, united in m/s;
v denotes the velocity of the flash flood and debris flow along the y-direction, united in m/s;
$${τ}_{*} = \frac{\sqrt{{{τ}_{bx}}^{2} + {{τ}_{by}}^{2}}}{( {ρ}_{s} - {ρ}_{w} ) {gd}_{c}}$$
denotes Shields number expressed in dimensionless units;
τ_{bx} denotes the bottom-bed resistance of the flash flood and debris flow along the x-direction, united in Pa;
τ_{by} denotes the bottom-bed resistance of the flash flood and debris flow along the y-direction, united in Pa;
ρₛ=2650 denotes the intrinsic density of the coarse particles in the flash flood and debris flow, united in kg/m³;
ρ_{w}=1000 denotes the density of the clear water, united in kg/m³;
d_{c} denotes the representative particle size of the coarse particles in the flash flood and debris flow, united in m;
g=9.81 denotes the gravitational acceleration, united in m/s²;
τ_{*c} denotes a critical Shields number, expressed in dimensionless units, and a calculation formula is:
$${τ}_{* c} = {τ}_{* c 0} \frac{sin ( {φ}_{bed} - θ )}{sin ( {φ}_{bed} )} [ 0.5 + 6 {( tan θ )}^{0.75} ]$$
wherein τ_{*c0}=0.045 denotes an empirical coefficient, expressed in dimensionless units;
θ denotes the slope angle, which is calculated from the topography, united in °;
φ_{bed} denotes a friction angle of particles when the debris flow erodes the trench, united in °.

9. The numerical simulation method for rainfall-induced the flash flood and debris flow of claim 1, wherein the bottom-bed resistance of the flash flood and debris flow along the x-direction ρ_{bx} and the bottom-bed resistance of the flash flood and debris flow along the y-direction τ_{by} are calculated:
$${τ}_{bx} = \frac{ρ {gn}^{2} p \sqrt{{p}^{2} + {q}^{2}}}{{h}^{7 / 3}} Γ + [ ( {c}_{f} + {c}_{w} ) {τ}_{fx} + {c}_{c} {τ}_{cx} ] ( 1 - Γ )$$
$${τ}_{by} = \frac{ρ {gn}^{2} p \sqrt{{p}^{2} + {q}^{2}}}{{h}^{7 / 3}} Γ + [ ( {c}_{f} + {c}_{w} ) {τ}_{fy} + {c}_{c} {τ}_{cy} ] ( 1 - Γ )$$
wherein ρ=c_{w}ρ_{w}+(c_{f}+c_{c})ρₛ denotes the density of the flash flood and debris flow, united in kg/m³;
c_{w} denotes the volumetric concentration of the water in the flash flood and debris flow, expressed in dimensionless units;
c_{c} denotes the volumetric concentration of the coarse particles in the flash flood and debris flow, expressed in dimensionless units;
c_{f} denotes the volumetric concentration of the fine particles in the flash flood and debris flow, expressed in dimensionless units;
ρₛ=2650 denotes the intrinsic density of the particles in the flash flood and debris flow, united in kg/m³;
ρ_{w}=1000 denotes the density of the clear water, united in kg/m³;
n denotes an roughness coefficient in the flash flood and debris flow, united in s/m^{1/3};
h denotes the flow depth of the flash flood and debris flow, united in m;
ρ=hu denotes the discharge per unit width of the flash flood and debris flow along the x-direction, united in m²/s;
q=hv denotes the discharge per unit width of the flash flood and debris flow along the y-direction, united in m²/s;
u denotes the velocity of the flash flood and debris flow along the x-direction, united in m/s;
v denotes the velocity of the flash flood and debris flow along the y-direction, united in m/s;
Γ denotes the transition factor from the flash flood to the debris flow, expressed in dimensionless units;
τ_{fx} and τ_{fy} denote bottom-bed resistances of liquid-phase mudflow of the flash flood and debris flow along the x-direction and the y-direction, respectively, united in Pa;
τ_{cx} and τ_{cy} denote bottom-bed resistances of the coarse particles in the flash flood and debris flow along the x-direction and the y-direction, respectively, united in Pa;
g=9.81 denotes the gravitational acceleration, united in m/s²;
the bottom-bed resistance of the liquid-phase mudflow of the flash flood and debris flow along the x-direction τ_{fx} and the bottom-bed resistance of the liquid-phase mudflow of the flash flood and debris flow along the y-direction τ_{fy} are calculated by following equations, respectively:
$${τ}_{fx} = 0.098 exp ( 8.45 \frac{{S}_{v} - {S}_{v 0}}{{S}_{vm}} + 1.5 ) + 3 {μ}_{0} {( 1 - {k}_{0} \frac{{S}_{v}}{{S}_{vm}} )}^{- 2.5} \frac{u}{h}$$
$${τ}_{fy} = 0.098 exp ( 8.45 \frac{{S}_{v} - {S}_{v 0}}{{S}_{vm}} + 1.5 ) + 3 {μ}_{0} {( 1 - {k}_{0} \frac{{S}_{v}}{{S}_{vm}} )}^{- 2.5} \frac{v}{h}$$
wherein h denotes the flow depth of the flash flood and debris flow, united in m
u denotes the velocity of the flash flood and debris flow along the x-direction, united in m/s;
v the velocity of the flash flood and debris flow along the y-direction, united in m/s;
μ₀=10⁻³ denotes a kinetic viscosity of water, united in Pa·s;
$${S}_{v} = \frac{{c}_{f}}{1 - {c}_{c}}$$
denotes volumetric concentration of the fine particles in the liquid slurry, expressed in dimensionless units;
Sᵥₘ denotes maximum permissible volumetric concentration of the fine particles in the liquid slurry, expressed in dimensionless units, which is calculated by following formula:
$${S}_{vm} = 0.92 - 0.2 {log}_{10} ( \sum \frac{{p}_{i}}{{d}_{i}} )$$
wherein dᵢ denotes a diameter of an ith particle size class in the fine particles sediment, expressed in mm;
pᵢ denotes a mass percentage of the ith particle size class in the fine particles sediment, expressed in dimensionless units;
Sᵥ₀ denotes critical volumetric concentration of fluid for a transition from a Newtonian fluid to a Bingham fluid, expressed in dimensionless units, which is calculated by:
$${S}_{v 0} = {1.26}_{vm}^{32}$$
k₀ denotes a correction coefficient, expressed in dimensionless units, which is expressed by:
$${k}_{0} = 1 + 2 {( \frac{{S}_{v}}{{S}_{vm}} )}^{0.3} {( 1 - \frac{{S}_{v}}{{S}_{vm}} )}^{4}$$
the bottom-bed resistance of the coarse particles along the x-direction τ_{cx} and the bottom-bed resistance of the coarse particles along the y-direction τ_{cy} in the flash flood and debris flow are calculated by following formulas, respectively:
$${τ}_{cx} = ( ρ - {ρ}_{f} ) gh cos {θ}_{x} tan {φ}_{s} \frac{p}{\sqrt{{p}^{2} + {q}^{2}}} + {c}_{c} {ρ}_{s} g \frac{p \sqrt{{p}^{2} + {q}^{2}}}{{h}^{2} {C}_{z}^{2}}$$
$${τ}_{cy} = ( ρ - {ρ}_{f} ) gh cos {θ}_{y} tan {φ}_{s} \frac{p}{\sqrt{{p}^{2} + {q}^{2}}} + {c}_{c} {ρ}_{s} g \frac{q \sqrt{{p}^{2} + {q}^{2}}}{{h}^{2} {C}_{z}^{2}}$$
wherein τ_{cx} denotes the bottom-bed resistance of the coarse particles along the x-direction in the flash flood and debris flow, united in Pa;
τ_{cy} denotes the bottom-bed resistance of the coarse particles along the y-direction in the flash flood and debris flow, united in Pa;
ρ=c_{w}ρ_{w}+(c_{f}+c_{c})ρₛ denotes the density of the flash flood and debris flow, united in kg/m³;
$${ρ}_{f} = \frac{1}{1 - {c}_{c}} \{ {ρ}_{s} {c}_{f} + {ρ}_{w} [ 1 - ( {c}_{f} + {c}_{c} ) ] \}$$
denotes density of liquid-phase mudflow consisting of the fine particles and the water, united in kg/m³;
c_{w} denotes the volumetric concentration of the water in the flash flood and debris flow, expressed in dimensionless units;
c_{c} denotes the volumetric concentration of the coarse particles in the flash flood and debris flow, expressed in dimensionless units;
c_{f} denotes the volumetric concentration of the fine particles in the flash flood and debris flow, expressed in dimensionless units;
ρₛ=2650 denotes the intrinsic density of the particles in the flash flood and debris flow, united in kg/m³;
ρ_{w}=1000 denotes the density of the clear water, united in kg/m³;
ρ=hu denotes the discharge per unit width of the flash flood and debris flow along the x-direction, united in m²/s;
q=hv denotes the discharge per unit width of the flash flood and debris flow along the y-direction, united in m²/s;
u denotes the velocity of the flash flood and debris flow along the x-direction, united in m/s;
v denotes the velocity of the flash flood and debris flow along the y-direction, united in m/s;
h denotes the flow depth of the flash flood and debris flow, united in m;
θₓ denotes a slope of the bottom-bed of the flash flood and debris flow along the x-direction, calculated from the topography, united in °;
θ_{y} denotes a slope of the bottom-bed of the flash flood and debris flow along the y-direction, calculated from the topography, united in °;
φₛ denotes the friction angle of between the coarse particles and the bottom bed in the flash flood and debris flow, united in °;
C_{z} denotes a turbulence coefficient of the coarse particles in the flash flood and debris flow, united in m^{1/2}/s;
g=9.81 denotes the gravitational acceleration, united in m/s².
